(19) United States
(12) Patent Application Publication
(10) Pub. No.: US 2025/0263524 A1
(43) Pub. Date: Aug. 21, 2025

(54) Method for Polycondensation of a Recycled Polyester

(71) Applicant: SI Group, Inc., The Woodlands, TX (US)

(72) Inventors: Jeroen Frederix, Antwerp (BE); Warren Ebenezer, Stockport (GB); Jianguo Zhou, Morgantown, WV (US); Michail Dolgovskij, Lake Jackson, TX (US); Kelly Chichak, Halfmoon, NY (US)

(21) Appl. No.: 19/057,653

(22) Filed: Feb. 19, 2025

Related U.S. Application Data
(60) Provisional application No. 63/555,223, filed on Feb. 19, 2024.
(60) Provisional application No. 63/561,350, filed on Mar. 5, 2024.

(51) Int. Cl. C08J 3/20; C08G 63/91; C08K 5/526

(52) U.S. Cl. CPC C08J 3/201; C08G 63/916; C08K 5/526; C08J 2367/02; C08K 2201/014

(57) ABSTRACT

The present disclosure is directed to a method of preparing a polyester from a recycled polyester material. The method utilizes one or more organic phosphite antioxidants as well as steps of melt-blending the recycled polyester material and the one or more organic phosphite antioxidants and thereafter subjecting such mixture to polycondensation. The present disclosure is also directed to a polycondensed polyester composition comprising a polycondensed polyester made from a recycled polyester material and one or more organic phosphite antioxidants. The polycondensed polyester composition can exhibit a desired color profile and/or intrinsic viscosity.

### CROSS-REFERENCE TO RELATED APPLICATIONS

The present application claims filing benefit of U.S. Provisional Patent Application No. 63/555,223 having a filing date of Feb. 19, 2024 and U.S. Provisional Patent Application No. 63/561,350 having a filing date of Mar. 5, 2024, which are hereby incorporated by reference in their entirety.

### BACKGROUND

Plastic waste has become one of the most complex environmental issues, especially in the context of increasing production and demand for plastic materials. However, finding technical solutions and methodologies to more efficiently process plastic waste and transform it poses a challenge. For instance, polyethylene terephthalate (PET) is a synthetic polyester widely used in the production of containers (e.g., beverage bottles), packaging, textiles, fibers, and other articles. PET is a thermoplastic made of repeating units of terephthalic acid and ethylene glycol, linked together via an ester bond which can be cleaved by hydrolysis to transform the PET waste back into its monomer constituents. However, certain current chemical methods of PET recycling require the use of organic solvents at high temperatures and pressures to achieve depolymerization into monomer derivatives in practical yields. Further, such methods may require additional complexities and costs due to the required depolymerization and repolymerization processes.

In this regard, solid state polymerization and liquid state polymerization have been utilized for PET, particularly recycled PET, such as mechanically recycled PET. In particular, such polymerization techniques may be utilized to increase the molecular weight and the intrinsic viscosity of the PET during the polymerization process. However, during such polymerization, the polycondensation reaction typically results in the formation of water which may affect the reaction time and the final properties of the PET.

As a result, there is a need for an improved method for polycondensation of polyesters, such as polyethylene terephthalate.

### SUMMARY

In accordance with one embodiment of the present disclosure, a method of preparing a polyester is disclosed. The method comprises: adding a recycled polyester material and one or more organic phosphite antioxidants into a melt blending apparatus; melt blending the recycled polyester material and the one or more organic phosphite antioxidants to form a melt-blended polyester composition; and polycondensing the melt-blended polyester composition via solid-state polymerization or liquid-state polymerization to form a polycondensed polyester composition comprising a polycondensed polyester and the one or more organic phosphite antioxidants. The polycondensed polyester composition exhibits an L* value of 60 or more and a b* value of 20 or less as determined in accordance with PET-S-09 (revision date Sep. 3, 2024).

In accordance with another embodiment of the present disclosure, a method of preparing a polyester is disclosed. The method comprises: adding a recycled polyester material and one or more organic phosphite antioxidants into a melt blending apparatus; melt blending the recycled polyester material and the one or more organic phosphite antioxidants to form a melt-blended polyester composition having a first intrinsic viscosity; and polycondensing the melt-blended polyester composition via solid-state polymerization or liquid-state polymerization to form a polycondensed polyester composition comprising a polycondensed polyester and the one or more organic phosphite antioxidants. The polycondensed polyester composition has a second intrinsic viscosity greater than the first intrinsic viscosity. The polycondensed polyester composition exhibits an intrinsic viscosity of 0.5 dl/g or more as determined in accordance with ASTM D4603-18.

In accordance with another embodiment of the present disclosure, a polycondensed polyester composition is disclosed. The polycondensed polyester composition comprises a polycondensed polyester formed from a recycled polyester material and one or more organic phosphite antioxidants. The polycondensed polyester composition exhibits an L* value of 60 or more and a b* value of 20 or less as determined in accordance with PET-S-09 (revision date Sep. 3, 2024) and an intrinsic viscosity of 0.5 dl/g or more as determined in accordance with ASTM D4603-18.

In accordance with another embodiment of the present disclosure, a method of preparing a polyester is disclosed. The method comprises: adding a recycled polyester material and one or more organic phosphite antioxidants into a melt blending apparatus, wherein the recycled polyester material has an L* value and a b* value as determined in accordance with PET-S-09 (revision date Sep. 3, 2024); melt blending the recycled polyester material and the one or more organic phosphite antioxidants to form a melt-blended polyester composition; and polycondensing the melt-blended polyester composition via solid-state polymerization or liquid-state polymerization to form a polycondensed polyester composition comprising a polycondensed polyester and the one or more organic phosphite antioxidants. The polycondensed polyester composition exhibits an L* value and a b* value as determined in accordance with PET-S-09 (revision date Sep. 3, 2024), wherein the L* value of the polycondensed polyester composition is greater than or equal to about the L* value of the recycled polyester material minus 3 and the b* value of the polycondensed polyester composition is less than or equal to about the b* value of the recycled polyester material plus 2

### BRIEF DESCRIPTION OF THE DRAWINGS

FIG. 1 illustrates the intrinsic viscosity and the color values of the samples of Example 1.

FIG. 2 illustrates the rate of change of the intrinsic viscosity of the samples of Example 2.

FIG. 3 illustrates the rate of change of the intrinsic viscosity and the b* values of the organic phosphite antioxidants utilized in Example 4.

FIGS. 4A, 4B, and 4C illustrate the L*, b*, and final intrinsic viscosity after rotovap-SSP as a function of the treatment rate of a particular organic phosphite antioxidant in Example 4.

FIGS. 5A, 5B, and 5C illustrate the L*, b*, and final intrinsic viscosity after rotovap-SSP as a function of the blend ratio of two organic phosphite antioxidants as demonstrated in Example 5.

FIGS. 6A and 6B illustrate the L* and b* values of a blend of two organic phosphite antioxidants as demonstrated in Example 6.

FIGS. 7A and 7B illustrate the L* and b* values of a blend of two organic phosphite antioxidants at various treatment rates in comparison to a commercially available additive as demonstrated in Example 7.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to an improved method of polycondensing a recycled polyester material. In particular, the method utilizes a combination of melt blending the recycled polyester material with one or more organic phosphite antioxidants as disclosed herein to form a melt-blended polyester composition and thereafter subjecting such melt-blended polyester composition to polycondensation resulting in a polycondensed polyester composition comprising a polycondensed polyester and the one or more organic phosphite antioxidants. Such polycondensation may be conducted via solid-state polymerization or liquid-state polymerization.

Without intending to be limited, the present inventors have discovered that the introduction of organic phosphite antioxidants during such process may provide certain benefits to the polycondensation process as well as the resulting polycondensed polyester and corresponding composition. In particular, the method disclosed herein may allow for the management and balancing of brightness, yellowness, and intrinsic viscosity of polycondensed polyesters and corresponding compositions thereby resulting in significant benefits to polymer recycling.

In general and without intending to be limited, recycled polyester materials may undergo yellowing due to repeated use and the polycondensation process. However, the present inventors have discovered that the utilization of the organic phosphite antioxidant(s) as disclosed herein can provide a resulting polycondensed polyester and corresponding composition with a desired color profile. In particular, the resulting polycondensed polyester and corresponding composition may exhibit reduced yellowing compared to a similar polycondensation process that may not utilize such organic phosphate antioxidant(s).

In general, the color profile may be indicated by L*, b*, and/or a* values in accordance with CIELAB (CIE 1976 color space) as determined in accordance with PET-S-09 (revision date Sep. 3, 2024) of The Association of Plastic Recyclers. The L* value may represent lightness, b* may represent the blue/yellow value, and a* may represent the red/green value.

In this regard, the present inventors have discovered that the method as disclosed herein can provide a resulting polycondensed polyester and corresponding composition with an acceptable L* value. For instance, in some embodiments, the L* value may not be reduced compared between the resulting polycondensed polyester and corresponding composition and the original recycled polyester material, melt-blended polyester material, and/or melt-blended polyester composition as disclosed herein. In certain embodiments, the L* value may even be improved thereby indicating improved lightness. Accordingly, L* may range from 50 to 90, such as from 60 to 90, such as from 60 to 80, such as from 60 to 75, such as from 65 to 75, such as from 65 to 70, such as from 67 to 69. For instance, L* may be 50 or more, such as 53 or more, such as 55 or more, such as 57 or more, such as 60 or more, such as 63 or more, such as 65 or more, such as 67 or more, such as 67.5 or more, such as 68 or more, such as 68.2 or more, such as 68.4 or more, such as 68.5 or more, such as 68.6 or more, such as 68.8 or more, such as 69 or more, such as 69.3 or more, such as 69.5 or more, such as 69.8 or more, such as 70 or more, such as 70.5 or more, such as 71 or more, such as 71.5 or more, such as 72 or more, such as 73 or more, such as 75 or more, such as 78 or more, such as 80 or more. Also, L* may be 90 or less, such as 85 or less, such as 80 or less, such as 77 or less, such as 75 or less, such as 73 or less, such as 72 or less, such as 71.5 or less, such as 71 or less, such as 70.5 or less, such as 70 or less, such as 69.5 or less, such as 69 or less, such as 68.5 or less, such as 68 or less, such as 67 or less, such as 65 or less, such as 63 or less. Such aforementioned values may be for the polycondensed polyester composition and/or the polycondensed polyester as defined herein.

In another embodiment, the relative change of the L* of the resulting polycondensed polyester and corresponding composition may be within a certain value of the L* of the original recycled polyester material, melt-blended polyester material, and/or melt-blended polyester composition. For instance, the original recycled polyester material, melt-blended polyester material, and/or melt-blended polyester composition may have an initial L* value. The L* value of the resulting polycondensed polyester and/or corresponding composition may be −3 or greater the L* value of the original recycled polyester material, melt-blended polyester material, and/or melt-blended polyester composition. Stated in other words, the L* value of the polycondensed polyester and/or the polycondensed polyester composition, such as the polycondensed polyester composition, may be greater than or equal to about the L* value of the recycled polyester material, melt-blended polyester material, and/or melt-blended polyester composition, such as the recycled polyester material, minus 3.

The difference (which may be incorporated into the aforementioned relationship of the relative change in L* value) in L* value may be −3 or greater, such as −2 or greater, such as −1 or more, such as 0 or greater, such as +0.3 or greater, such as +0.6 or greater, such as +0.9 or greater, such as +1 or greater, such as +1.5 or greater, such as +2 or greater, such as +2 or greater, such as +2.5 or greater. The difference in L* value may be +15 or less, such as +12 or less, such as +10 or less, such as +9 or less, such as +8 or less, such as +7 or less, such as +6 or less, such as +5 or less, such as +4 or less, such as +3 or less, such as +2.5 or less, such as +2.3 or less, such as +2 or less, such as +1.8 or less, such as +1.6 or less, such as +1.4 or less, such as +1.2 or less, such as +1 or less, such as +0.8 or less. In certain embodiments, the L* of the resulting polycondensed polyester and corresponding composition may be greater than the L* of the original recycled polyester material, melt-blended polyester material, and/or melt-blended polyester composition. In certain embodiments, the aforementioned L* value may be in relation to the original recycled polyester material. In other embodiments, the aforementioned L* value may be in relation to the melt-blended polyester material.

In addition, b* may range from −10 to 20, such as from −5 to 20, such as from −3 to 20, such as from −3 to 15, such as from −3 to 12, such as from −3 to 10, such as from −3 to 8, such as from −3 to 5, such as from −3 to 3, such as from −2 to 2, such as from −1 to 0. In other embodiments, b* may range from −10 to 20, such as from −5 to 20, such as from −3 to 20, such as from 0 to 20, such as from 1 to 20, such as from 3 to 20, such as from 5 to 20, such as from 8 to 20, such as from 10 to 20, such as from 10 to 15. For instance, b* may be −10 or more, such as −8 or more, such as −6 or more, such as −5 or more, such as −4 or more, such as −3 or more, such as −2 or more, such as −1 or more, such as −0.5 or more, such as 0 or more, such as 0.3 or more such as 0.5 or more, such as 0.8 or more, such as 1 or more, such as 1.5 or more, such as 2 or more, such as 3 or more, such as 5 or more, such as 8 or more, such as 10 or more, such as 12 or more, such as 14 or more. Also, b* may be 20 or less, such as 18 or less, such as 16 or less, such as 14 or less, such as 12 or less, such as 10 or less, such as 8 or less, such as 6 or less, such as 5 or less, such as 4 or less, such as 3 or less, such as 2.5 or less, such as 2 or less, such as 1.8 or less, such as 1.6 or less, such as 1.5 or less, such as 1.4 or less, such as 1.3 or less, such as 1.2 or less, such as 1.1 or less, such as 1 or less, such as 0.9 or less, such as 0.8 or less, such as 0.7 or less, such as 0.6 or less, such as 0.5 or less. Such aforementioned values may be for the polycondensed polyester composition and/or the polycondensed polyester as defined herein.

In another embodiment, the relative change of the b* of the resulting polycondensed polyester and corresponding composition may be within a certain value of the b* of the original recycled polyester material, melt-blended polyester material, and/or melt-blended polyester composition. For instance, the original recycled polyester material, melt-blended polyester material, and/or melt-blended polyester composition may have an initial b* value. The b* value of the resulting polycondensed polyester and corresponding composition may be +2 or less the b* value of the original recycled polyester material, melt-blended polyester material, and/or melt-blended polyester composition. Stated in other words, the b* value of the polycondensed polyester and/or the polycondensed polyester composition, such as the polycondensed polyester composition, may be less than or equal to about the b* value of the recycled polyester material, melt-blended polyester material, and/or melt-blended polyester composition, such as the recycled polyester material, plus 2.

For instance, the difference (which may be incorporated into the aforementioned relationship of the relative change in b* value) in b* value may be +2 or less, such as +1.5 or less, such as +1.3 or less, such as +1 or less, such as +0.8 or less, such as +0.5 or less, such as +0.3 or less, such as 0 or less, such as −0.1 or less, such as −0.3 or less, such as −0.5 or less, such as −1 or less, such as −1.5 or less, such as −2 or less, such as −3 or less, such as −4 or less, such as −5 or less, such as −6 or less, such as −7 or less, such as −8 or less, such as −9 or less, such as −10 or less, such as −12 or less, such as −14 or less, such as −16 or less. The difference in b* value may be −20 or more, such as −18 or more, such as −16 or more, such as −14 or more, such as −12 or more, such as −10 or more, such as −8 or more, such as −6 or more, such as −5 or more, such as −4 or more, such as −3 or more, such as −2 or more, such as −1 or more, such as 0 or more. In certain embodiments, the b* of the resulting polycondensed polyester and corresponding composition may be less than the b* of the original recycled polyester material, melt-blended polyester material, and/or melt-blended polyester composition. In certain embodiments, the aforementioned b* value may be in relation to the original recycled polyester material. In other embodiments, the aforementioned b* value may be in relation to the melt-blended polyester material.

In addition, a* may range from −10 to 10, such as from −10 to 5, such as from −10 to 0, such as from −5 to 0, such as from −3 to −1. For instance, a* may be −10 or more, such as −8 or more, such as −6 or more, such as −5 or more, such as −4 or more, such as −3 or more, such as −2 or more, such as −1 or more, such as 0 or more. Also, a* may be 10 or less, such as 8 or less, such as 6 or less, such as 5 or less, such as 3 or less, such as 2 or less, such as 1 or less, such as 0 or less, such as −1 or less. Such aforementioned values may be for the polycondensed polyester composition and/or the polycondensed polyester as defined herein.

In addition, the polycondensed polyester composition and/or the polycondensed polyester may exhibit a desired yellowness index (YI). The yellowness index may be determined in accordance with ASTM E313-20. In this regard, YI may range from −10 to 10, such as from −5 to 5, such as from −2 to 5, such as from −1 to 5, such as from −0.5 to 5, such as from 0 to 5, such as from 0.5 to 4, such as from 1 to 4, such as from 1 to 3. For instance, the yellowness index may be −10 or more, such as −8 or more, such as −6 or more, such as −5 or more, such as −4 or more, such as −3 or more, such as −2 or more, such as −1 or more, such as −0.5 or more, such as 0 or more, such as 0.3 or more such as 0.5 or more, such as 0.8 or more, such as 1 or more, such as 1.3 or more, such as 1.5 or more. The yellowness index may be 10 or less, such as 8 or less, such as 6 or less, such as 5 or less, such as 4 or less, such as 3.5 or less, such as 3 or less, such as 2.8 or less, such as 2.5 or less, such as 2.3 or less, such as 2 or less, such as 1.8 or less, such as 1.6 or less, such as 1.5 or less, such as 1.4 or less, such as 1.3 or less, such as 1.2 or less, such as 1.1 or less, such as 1 or less, such as 0.9 or less, such as 0.8 or less, such as 0.7 or less, such as 0.6 or less, such as 0.5 or less. Such aforementioned values may be for the polycondensed polyester composition and/or the polycondensed polyester as defined herein.

In addition to the color profile as mentioned above, the resulting polycondensed polyester composition and/or polycondensed polyester may exhibit a desired intrinsic viscosity. For instance, in some embodiments, the intrinsic viscosity may be increased compared between the resulting polycondensed polyester and corresponding composition and the original recycled polyester material, melt-blended polyester material, and/or melt-blended polyester composition as disclosed herein. In such embodiments, such an increase in intrinsic viscosity may suggest an increase in the molecular weight. Nevertheless, the method may provide a resulting polycondensed polyester and corresponding composition having a desired intrinsic viscosity as further described herein. In general and without intending to be limited, the intrinsic viscosity at a certain level may be desired in order to meet IV specifications required for certain applications and industries.

Further, the present inventors have also discovered that while hydrolysis of the organic phosphite antioxidant(s) may generally be undesired, it may be beneficial during the subsequent polymerization and polycondensation. In particular, this may assist in removal of water generated during the polycondensation thereby allowing for the polymerization and polycondensation to proceed in a favorable direction. Accordingly, without intending to be limited, this may result in faster polymerization time and potentially avoid or minimize the need for post-polymerization processes. Further, water generated during polycondensation may generally result in chain scission of the polyester, thereby essentially decreasing the molecular weight and the intrinsic viscosity. As a result, hydrolysis of the organic phosphite antioxidant(s) by reaction with water can prevent or minimize chain scission of the polyester.

In addition, the method as disclosed herein may also have other added benefits. For instance, the method may be beneficial in the circular plastics industry with the ability to better recycle plastics, particularly polyethylene terephthalate. In addition, utilizing the method as disclosed herein, reduced acetaldehyde levels may be realized after melt-blending and after polycondensation. Such reduction in acetaldehyde can be beneficial for the environment as well as personal health. In this regard, the method and disclosure as provided herein exhibits multiple benefits and advantages not yet realized in the art.

While the aforementioned refers to the method as disclosed herein, the present disclosure is also directed to a polycondensed polyester composition. The polycondensed polyester composition comprises a polycondensed polyester and one or more organic phosphite antioxidants. Furthermore, the polycondensed polyester may be made from a recycled polyester material as disclosed herein. Even further, the polycondensed polyester and the corresponding polycondensed polyester composition may exhibit any one or more of the attributes mentioned above and herein.

### Recycled Polyester Material

As indicated above, the present disclosure is directed to an improved method of polycondensing a recycled polyester material as well as a polycondensed polyester and corresponding composition.

The source of the recycled polyester material is not necessarily limited by the present disclosure. For instance, the recycled polyester material may be a post-consumer material, a post-industrial material, or a mixture thereof. Furthermore, such recycled polyester material may have initially been synthesized using standard techniques known in the art, such as solution polymerization or melt polymerization. The reaction conditions of such solution polymerization or melt polymerization are not necessarily limited by the present disclosure.

In addition, the form of the recycled polyester material utilized in accordance with the present disclosure is also not limited by the present disclosure. For instance, the form of the recycled polyester material may be pellets, chips, flakes, powder, etc.

In general, the recycled polyester material includes a polyester. The polyester may include one or more polyesters. The polyester may be a thermoplastic polyester, a thermoset polyester, or a mixture thereof. In one embodiment, the polyester may be a thermoplastic polyester. In another embodiment, the polyester may be a thermoset polyester.

The polyester may be an aliphatic polyester, an aromatic polyester, or a mixture thereof. In one embodiment, the polyester may be an aliphatic polyester. In another embodiment, the polyester may be an aromatic polyester.

In general, the polyester may be derived from a diol having from 2 to 10 carbon atoms. For instance, such diol may be an aliphatic diol, a cycloaliphatic diol, or a mixture thereof. In one embodiment, such diol may be an aliphatic diol. In addition to the diol, the polyester may also be derived from a dicarboxylic acid. For instance, such dicarboxylic acid may be an aliphatic dicarboxylic acid, a dicarboxylic acid, or a mixture thereof. In one embodiment, such dicarboxylic acid may be an aromatic dicarboxylic acid.

The diol is not necessarily limited by the present disclosure. For instance, the diol may be ethylene glycol, 1,4-butanediol, cyclohexane dimethanol (e.g., 1,4-cyclohexanedimethanol), propylene glycol, 1,6-hexanediol, neopentyl glycol, decamethylene glycol, poly(oxy)ethylene glycol, polytetramethylene glycol, polymethylene glycol, or a mixture thereof. In one embodiment, the diol may be ethylene glycol. In another embodiment, the diol may be 1,4-butanediol. In a further embodiment, the diol may be 1,4-cyclohexanedimethanol.

In one embodiment, the diol may be an alkylene glycol. For instance, such a glycol may include, but is not limited to, ethylene glycol, propylene glycol, 1,4-butanediol, or a mixture thereof.

The acid is not necessarily limited by the present disclosure. For instance, the acid may be adipic acid, sebacic acid, succinic acid, oxalic acid, isophthalic acid, terephthalic acid, or a mixture thereof. In one embodiment, the acid may be an aliphatic acid. In this regard, the acid may be adipic acid, sebacic acid, succinic acid, oxalic acid, or a mixture thereof. In one embodiment, the acid may be an aromatic acid. In this regard, the acid may be isophthalic acid, terephthalic acid, or a mixture thereof.

In one embodiment, the acid may be isophthalic acid. In another embodiment, the acid may be terephthalic acid. In a further embodiment, the acid may be a mixture of isophthalic acid and terephthalic acid. In this regard, with respect to the aforementioned aromatic acids, such acid may include at least one aromatic nucleus. However, it should be understood that fuse rings may also be utilized. In this regard, the acid may also include 1,4-, 1,5-, or 2,6-naphthalene-dicarboxylic acid.

The polyester may comprise a polyalkylene terephthalate. While the polyester is not necessarily limited by the present disclosure, the polyester may include, but is not limited to, polyethylene terephthalate, polybutylene terephthalate, and polycyclohexanedimethylene terephthalate, etc. as well as mixtures thereof and copolymers thereof. In one embodiment, the polyester may be polyethylene terephthalate. In another embodiment, the polyester may be polybutylene terephthalate. In a further embodiment, the polyester may be polycyclohexanedimethylene terephthalate.

Related, the polyester may comprise a polyalkylene naphthalate. For instance, the polyester may be polyethylene naphthalate and polybutylene naphthalate, or a mixture thereof. In one embodiment, the polyester may be polyethylene naphthalate. In another embodiment, the polyester may be polybutylene naphthalate.

Regarding the properties of the polyester, it may be desired to have a melt flow that can allow it to be processed in a relatively easy manner for the formation of a melt-blended polyester composition. In this regard, the polyester may exhibit a relatively low melt viscosity as indicated by the melt flow rate. For instance, the melt flow rate of the polyester may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 10 g/10 min or more, such as about 20 g/10 min or more, such as about 30 g/10 min or more, such as about 40 g/10 min or more, such as about 60 g/10 min or more, such as about 80 g/10 min or more. The melt flow rate may be about 100 g/10 min or less, such as about 90 g/10 min or less, such as about 80 g/10 min or less, such as about 70 g/10 min or less, such as about 60 g/10 min or less, such as about 50 g/10 min or less, such as about 40 g/10 min or less, such as about 30 g/10 min or less, such as about 20 g/10 min or less, such as about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The polyester can include a solid, generally high molecular weight polymeric material. The polyester may have a Mw of 10,000 g/mol or more, such as 20,000 g/mol or more, such as 30,000 g/mol or more, such as 40,000 g/mol or more, such as 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 200,000 g/mol or less, such as 100,000 g/mol or less, such as 80,000 g/mol or less, such as 50,000 g/mol or less, such as 40,000 g/mol or less, such as 30,000 g/mol or less, such as 20,000 g/mol or less. Furthermore, the polyester may have a Mn of 10,000 g/mol or more, such as 20,000 g/mol or more, such as 30,000 g/mol or more, such as 40,000 g/mol or more, such as 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 200,000 g/mol or less, such as 100,000 g/mol or less, such as 80,000 g/mol or less, such as 50,000 g/mol or less, such as 40,000 g/mol or less, such as 30,000 g/mol or less, such as 20,000 g/mol or less. In general, the molecular weight may be characterized by GPC (gel permeation chromatography) using polystyrene standards.

The polyester may have a certain melting temperature. For instance, the melting temperature may be about 60° C. or more, such as about 80° C. or more, such as about 100° C. or more, such as about 120° C. or more, such as about 140° C. or more, such as about 160° C. or more, such as about 180° C. or more, such as about 200° C. or more, such as about 220° C. or more, such as about 240° C. or more, such as about 260° C. or more, such as about 280° C. or more. The melting temperature may be about 400° C. or less, such as about 380° C. or less, such as about 360° C. or less, such as about 340° C. or less, such as about 320° C. or less, such as about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less, such as about 100° C. or less. The melting temperature may be determined using means known in the art, such as differential scanning calorimetry in accordance with ISO 11357-1:2023 at a rate of 10° C./min.

In addition, the glass transition temperature of the polyester may be within a particular range. For instance, the glass transition temperature may be about 0° C. or more, such as about 10° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more, such as about 100° C. or more, such as about 120° C. or more, such as about 140° C. or more, such as about 160° C. or more, such as about 180° C. or more. The glass transition temperature may be about 220° C. or less, such as about 200° C. or less, such as about 190° C. or less, such as about 170° C. or less, such as about 150° C. or less, such as about 130° C. or less, such as about 110° C. or less, such as about 100° C. or less, such as about 90° C. or less, such as about 80° C. or less, such as about 70° C. or less, such as about 60° C. or less. The glass transition temperature may be determined using means known in the art, such as differential scanning calorimetry in accordance with ISO 11357-1:2023 at a rate of 10° C./min.

The polyester may be a crystalline polyester in one embodiment or a semi-crystalline polyester in another embodiment. The polyester may be amorphous in a further embodiment. The crystallinity may be at least 5%, such as at least 10%, such as at least 15%, such as at least 20%, such as at least 25%, such as at least 35%, such as at least 45%, such as at least 55%, such as at least 65%, such as at least 70% by weight. The crystallinity may be determined by differential scanning calorimetry. For instance, crystallinity may be determined by dividing the heat of fusion of a sample by the heat of fusion of a 100% crystalline recycled polyester.

Furthermore, it should be understood that a mixture of two or more polyesters, in particular thermoplastic polyesters, can be used. In one embodiment, a respective polyester material and/or a respective composition may contain one polyester as defined herein. In other embodiments, a respective polyester material and/or a respective composition may include a mixture of polyesters. For instance, more than one polyester, such as two or three polyesters, may be utilized in a respective polyester material and/or a respective composition.

In one embodiment, the polyester may be present in the polyester material in an amount sufficient to form a continuous phase or matrix. Similarly, in one embodiment, the polyester may be present in a respective composition in an amount sufficient to form a continuous phase or matrix. In one embodiment, the aforementioned composition may refer to the melt-blended polyester composition as defined herein. In another embodiment, the aforementioned composition may refer to the polycondensed polyester composition as defined herein.

The polyester material may generally comprise about 50 wt. % or more, such as about 60 wt. % or more, such as about 70 wt. % or more, such as about 80 wt. % or more, such as about 85 wt. % or more, such as about 90 wt. % or more, such as about 93 wt. % or more, such as about 95 wt. % or more, such as about 97 wt. % or more, such as about 98 wt. % or more, such as about 99 wt. % or more of the polyester (e.g., one or more polyesters) based on the weight of the polyester material. The polyester material may comprise about 99.99 wt. % or less, such as about 99.9 wt. % or less, such as about 99.8 wt. % or less, such as about 99.5 wt. % or less, such as about 99 wt. % or less, such as about 98 wt. % or less, such as about 97 wt. % or less, such as about 96 wt. % or less, such as about 95 wt. % or less, such as about 93 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less of the polyester (e.g., one or more polyesters) based on the weight of the polyester material.

A respective polyester composition may generally comprise about 50 wt. % or more, such as about 60 wt. % or more, such as about 70 wt. % or more, such as about 80 wt. % or more, such as about 85 wt. % or more, such as about 90 wt. % or more, such as about 93 wt. % or more, such as about 95 wt. % or more, such as about 97 wt. % or more, such as about 98 wt. % or more, such as about 99 wt. % or more of the polyester (e.g., one or more polyesters) based on the weight of the composition. The composition may comprise about 99.99 wt. % or less, such as about 99.9 wt. % or less, such as about 99.8 wt. % or less, such as about 99.5 wt. % or less, such as about 99 wt. % or less, such as about 98 wt. % or less, such as about 97 wt. % or less, such as about 96 wt. % or less, such as about 95 wt. % or less, such as about 93 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less of the polyester (e.g., one or more polyesters) based on the weight of the composition. In one embodiment, the aforementioned composition may refer to the melt-blended polyester composition as defined herein. In another embodiment, the aforementioned composition may refer to the polycondensed polyester composition as defined herein. For instance, it may refer to the polycondensed polyester formed from the polycondensation.

### Organic Phosphite Antioxidants

As indicated above, the present disclosure is directed to an improved method of polycondensing a recycled polyester material as well a polycondensed polyester and corresponding composition. Such method utilizes one or more organic phosphite antioxidants as further described herein. In particular, an organic phosphite antioxidant is melt blended with a recycled polyester material to form a melt-blended polyester composition that will be subjected to a polycondensation, either via solid-state polymerization or liquid-state polymerization. Such polycondensation will yield a polycondensed polyester composition comprising a polycondensed polyester and the one or more organic phosphite antioxidants. In certain embodiments, the polycondensed polyester composition may also include a hydrolyzed derivative of at least one of the one or more organic phosphite antioxidants as further described herein.

In one embodiment, the method and resulting compositions may include only one organic phosphite antioxidant. In another embodiment, the method and resulting compositions may include at least two organic phosphite antioxidants. In such embodiments, at least one organic phosphite antioxidant may be a primary antioxidant. For instance, such primary antioxidant may be present in an amount of more than 50 wt. %, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more, such as 97 wt. % or more, such as 99 wt. % or more, such as 99.5 wt. % or more, such as 99.9 wt. % or more based on the total weight of the organic phosphite antioxidants.

In certain embodiments, at least one of the one or more organic phosphite antioxidants may include a phosphite ester. The phosphite ester may be an alkylphosphite ester, an arylphosphite ester, an alkylarylphosphite ester (including both alkyl and aryl groups), or a mixture thereof. In general, phosphite ester antioxidants may have a number of structures and are not necessarily limited by the present disclosure. In one embodiment, the phosphite ester may have the following structure (VI):

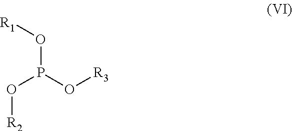

wherein
R₁, R₂, and R₃ are each independently an alkyl, an aryl, or a polyether.

In one embodiment, at least one of R₁, R₂, and R₃ may be alkyl. In another embodiment, at least two of R₁, R₂, and R₃ may be alkyl. In a further embodiment, all three of R₁, R₂, and R₃ may be alkyl. In one embodiment, the alkyl may be an unsubstituted alkyl. In another embodiment, the alkyl may be a substituted alkyl. For instance, the alkyl may be an arylkyl (i.e., an alkyl substituted with an aryl group).

For instance, the alkyl may be a C₁-C₅₀ alkyl. In this regard, the alkyl may be a C₁-C₅₀ alkyl, such as a C₂-C₄₀ alkyl, such as a C₃-C₃₀ alkyl, such as a C₄-C₂₀ alkyl. For instance, the alkyl may have 1 or more, such as 2 or more, such as 3 or more, such as 4 or more, such as 5 or more, such as 8 or more, such as 10 or more, such as 14 or more, such as 18 or more, such as 20 or more, such as 24 or more, such as 28 or more, such as 30 or more, such as 34 or more, such as 38 or more, such as 40 or more, such as 44 or more carbon atoms. The alkyl may have 50 or less, such as 46 or less, such as 42 or less, such as 40 or less, such as 38 or less, such as 34 or less, such as 30 or less, such as 26 or less, such as 22 or less, such as 20 or less, such as 18 or less, such as 16 or less, such as 14 or less, such as 10 or less, such as 8 or less, such as 6 or less, such as 5 or less, such as 4 or less, such as 3 or less, such as 2 or less carbon atoms. In this regard, the alkyl may be octadecyl, hexadecyl, butyldecyl, dodecyl, decyl, nonyl, octyl, heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Regarding the substituted alkyl, it may be an arylkyl (i.e., an alkyl substituted with an aryl group) in one embodiment. The aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

In one embodiment, at least one of R₁, R₂, and R₃ may be aryl. In another embodiment, at least two of R₁, R₂, and R₃ may be aryl. In a further embodiment, all three of R₁, R₂, and R₃ may be aryl. In one embodiment, the aryl may be an unsubstituted aryl. In another embodiment, the aryl may be a substituted aryl. For instance, the aryl may be an alkaryl (i.e., an aryl substituted with one or more alkyl groups).

For instance, the aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

Regarding the substituted aryl, it may be an alkaryl (i.e., an aryl substituted with one or more alkyl groups). The alkyl may be a C₁-C₁₀ alkyl. In this regard, the alkyl may be a C₁-C₁₀ alkyl, such as a C₁-C₈ alkyl, such as a C₁-C₆ alkyl, such as a C₂-C₆ alkyl, such as a C₄-C₆ alkyl, such as a C₅ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be pentyl (e.g., tert-amyl or tert-pentyl). In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

In one embodiment, at least one of R₁, R₂, and R₃ may be a polyether. In another embodiment, at least two of R₁, R₂, and R₃ may be a polyether. In a further embodiment, all three of R₁, R₂, and R₃ may be a polyether. As generally known in the art, such polyethers are compounds having at least one ether group. In this regard, the polyether may be a C₂ polyether, a C₃ polyether, or a C₄ polyether. For instance, in one embodiment, the polyether may be a polyethylene glycol. In another embodiment, the polyether may be a polypropylene glycol. In an even further embodiment, the polyether may be a polytetramethylene glycol. The polyether may have a weight average molecular weight of 200 g/mol or more, such as 300 g/mol or more, such as 400 g/mol or more, such as 500 g/mol, such as 750 g/mol or more, such as 1,000 g/mol or more to 10,000 g/mol or less, such as 7,500 g/mol or less, such as 5,000 g/mol or less, such as 4,000 g/mol or less, such as 3,000 g/mol or less, such as 2,500 g/mol or less, such as 2,000 g/mol or less, such as 1,500 g/mol or less, such as 1,250 g/mol or less, such as 1,000 g/mol or less.

In this regard, in one embodiment, the phosphite ester may be a trialkyl phosphite. In another embodiment, the phosphite ester may be a triaryl phosphite. In a further embodiment, the phosphite ester may be a dialkyl monoaryl phosphite. For instance, at least two of R₁, R₂, and R₃ may be alkyl as defined herein while the remaining of R₁, R₂, and R₃ may be aryl as defined herein. In an even further embodiment, the phosphite ester may be a diaryl monoalkyl phosphite. For instance, at least two of R₁, R₂, and R₃ may be aryl as defined herein while the remaining of R₁, R₂, and R₃ may be alkyl as defined herein.

In particular, when R₁, R₂, and R₃ are aryl (e.g., alkaryl), the phosphite ester may have the following structure (VII):

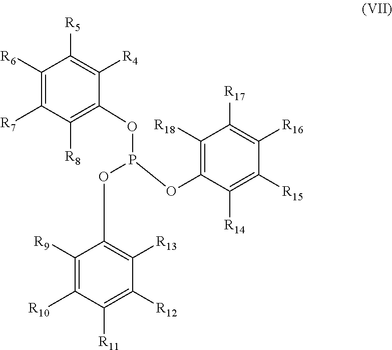

wherein
R₄, R₅, R₆, R₇, R₈, R₉, R₁₀, R₁₁, R₁₂, R₁₃, R₁₄, R₁₅, R₁₆, R₁₇, and R₁₈ are independently hydrogen or an alkyl.

In this regard, in one embodiment, the substituent groups of the aforementioned structure may all be hydrogen. However, as indicated above, the substituent groups may independently be an alkyl. The alkyl may correspond to those mentioned herein. For instance, the alkyl may be a C₁-C₁₀ alkyl. In this regard, the alkyl may be a C₁-C₁₀ alkyl, such as a C₁-C₈ alkyl, such as a C₁-C₆ alkyl, such as a C₂-C₆ alkyl, such as a C₄-C₆ alkyl, such as a C₅ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be pentyl (e.g., tert-amyl or tert-pentyl). In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Furthermore, a respective aryl group may have at least one alkyl substitution. In this regard, at least one, such as at least two, such as all three of the aryl groups may have at least one alkyl substitution. Accordingly, in one embodiment, at least one of R₄, R₅, R₆, R₇, and R₈ may be an alkyl. In one embodiment, at least one of R₉, R₁₀, R₁₁, R₁₂, and R₁₃ may be an alkyl. In one embodiment, at least one of R₁₄, R₁₅, R₁₆, R₁₇, and R₁₈ may be an alkyl. In this regard, at least one of R₄, R₅, R₆, R₇, and R₈, at least one of R₉, R₁₀, R₁₁, R₁₂, and R₁₃, and at least one of R₁₄, R₁₅, R₁₆, R₁₇, and R₁₈ may be an alkyl as defined above. In addition, in one embodiment, such alkyl substitution may be at the para position. Any remaining substituent groups may independently be hydrogen.

Furthermore, a respective aryl group may have at least two alkyl substitutions. Accordingly, in one embodiment, at least two of R₄, R₅, R₆, R₇, and R₈ may be an alkyl. In one embodiment, at least two of R₉, R₁₀, R₁₁, R₁₂, and R₁₃ may be an alkyl. In one embodiment, at least two of R₁₄, R₁₅, R₁₆, R₁₇, and R₁₈ may be an alkyl. In this regard, at least two of R₄, R₅, R₆, R₇, and R₈, at least two of R₉, R₁₀, R₁₁, R₁₂, and R₁₃, and at least two of R₁₄, R₁₅, R₁₆, R₁₇, and R₁₈ may be an alkyl as defined above. In addition, in one embodiment, such alkyl substitutions may be at the para position and the ortho position. Any remaining substituent groups may independently be hydrogen.

In this regard, in one embodiment, the organic phosphite antioxidant may have the following structure (I):

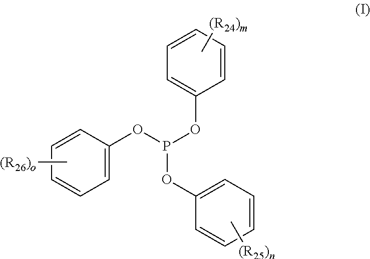

wherein,
R₂₄, R₂₅, and R₂₆ are each independently hydrogen, alkyl, alkenyl, alkynyl, or aryl provided that at least one of R₂₄, R₂₅, and R₂₆ is not hydrogen; and
m, n, and o are each independently from 0 to 3.

As indicated above, R₂₄, R₂₅, and R₂₆ are each independently hydrogen, alkyl, alkenyl, alkynyl, or aryl provided that at least one of R₂₄, R₂₅, and R₂₆ is not hydrogen. In this regard, at least one, such as at least two of R₂₄, R₂₅, and R₂₆ may be hydrogen provided that at least one of R₂₄, R₂₅, and R₂₆ is not hydrogen. Accordingly, in one embodiment, at least one of R₂₄, R₂₅, and R₂₆ may be an alkyl. In another embodiment, at least one of R₂₄, R₂₅, and R₂₆ may be an alkenyl. In a further embodiment, at least one of R₂₄, R₂₅, and R₂₆ may be an alkynyl. In another further embodiment, at least one of R₂₄, R₂₅, and R₂₆ may be an aryl.

In particular, R₂₄, R₂₅, and R₂₆ may each independently be a C₁-C₂₀ alkyl, a C₂-C₂₀ alkenyl, a C₂-C₂₀ alkynyl, or a C₃-C₁₂ aryl. In this regard, in one embodiment, at least one of R₂₄, R₂₅, and R₂₆ may be a C₁-C₂₀ alkyl. In another embodiment, at least one of R₂₄, R₂₅, and R₂₆ may be a C₂-C₂₀ alkenyl. In a further embodiment, at least one of R₂₄, R₂₅, and R₂₆ may be a C₂-C₂₀ alkynyl. In another further embodiment, at least one of R₂₄, R₂₅, and R₂₆ may be a C₃-C₁₂ aryl.

As indicated above, in one embodiment, at least one of, such as at least two of, such as all three of R₂₄, R₂₅, and R₂₆ may include an alkyl. In particular, it may include a C₁-C₂₀ alkyl. In this regard, the alkyl may be a C₁-C₂₀ alkyl, such as a C₁-C₁₆ alkyl, such as a C₁-C₁₂ alkyl, such as a C₁-C₁₀ alkyl, such as a C₂-C₈ alkyl, such as a C₃-C₆ alkyl, such as a C₄-C₆ alkyl. For instance, the alkyl may have 1 or more, such as 2 or more, such as 3 or more, such as 4 or more, such as 5 or more, such as 6 or more, such as 8 or more, such as 10 or more carbon atoms. The alkyl may have 20 or less, such as 18 or less, such as 16 or less carbon atoms, such as 14 or less, such as 12 or less, such as 10 or less, such as 8 or less, such as 6 or less carbon atoms. In addition, the alkyl may be a straight chain or a branched chain. In one embodiment, the alkyl is a straight chain. In another embodiment, the alkyl is a branched chain.

In one particular embodiment, at least one of R₂₄, R₂₅, and R₂₆ may be tert-butyl or tert-pentyl. For instance, at least one of, such as at least two of, such as at least three of R₂₄, R₂₅, and R₂₆ may be tert-butyl. In another embodiment, at least one of, such as at least two of, such as at least three of R₂₄, R₂₅, and R₂₆ may be tert-pentyl.

In one embodiment, the organic phosphite antioxidant may include a very low amount of certain alkyls. For example, such alkyls may be C₈-C₁₀, in particular C₉ alkyls. In this regard, in one embodiment, the alkyl may comprise less than 1,000 ppm, such as less than 500 ppm, such as less than 100 ppm, such as less than 50 ppm, such as less than 25 ppm, such as less than 10 ppm, such as less than 5 ppm, such as less than 1 ppm, such as 0 ppm of such alkyl.

As indicated above, in one embodiment, at least one of, such as at least two of, such as all three of R₂₄, R₂₅, and R₂₆ may include an alkenyl. In particular, it may include a C₂-C₂₀ alkenyl. In this regard, the alkenyl may be a C₂-C₂₀ alkenyl, such as a C₂-C₁₆ alkenyl, such as a C₂-C₁₂ alkenyl, such as a C₂-C₁₀ alkenyl, such as a C₂-C₈ alkenyl, such as a C₃-C₆ alkenyl, such as a C₄-C₆ alkenyl. For instance, the alkenyl may have 2 or more, such as 3 or more, such as 4 or more, such as 5 or more, such as 6 or more, such as 8 or more, such as 10 or more, such as 12 or more, such as 14 or more, such as 16 or more carbon atoms. The alkenyl may have 20 or less, such as 18 or less, such as 16 or less carbon atoms, such as 14 or less, such as 12 or less, such as 10 or less, such as 8 or less, such as 6 or less carbon atoms. In addition, the alkenyl may be a straight chain or a branched chain. In one embodiment, the alkenyl is a straight chain. In another embodiment, the alkenyl is a branched chain.

As indicated above, in one embodiment, at least one of, such as at least two of, such as all three of R₂₄, R₂₅, and R₂₆ may include an alkynyl. In particular, it may include a C₂-C₂₀ alkynyl. In this regard, the alkynyl may be a C₂-C₂₀ alkynyl, such as a C₂-C₁₆ alkynyl, such as a C₂-C₁₂ alkynyl, such as a C₂-C₁₀ alkynyl, such as a C₂-C₈ alkynyl, such as a C₃-C₆ alkynyl, such as a C₄-C₆ alkynyl. For instance, the alkynyl may have 2 or more, such as 3 or more, such as 4 or more, such as 5 or more, such as 6 or more, such as 8 or more, such as 10 or more, such as 12 or more, such as 14 or more, such as 16 or more carbon atoms. The alkynyl may have 20 or less, such as 18 or less, such as 16 or less carbon atoms, such as 14 or less, such as 12 or less, such as 10 or less, such as 8 or less, such as 6 or less carbon atoms. In addition, the alkynyl may be a straight chain or a branched chain. In one embodiment, the alkynyl is a straight chain. In another embodiment, the alkynyl is a branched chain.

As indicated above, in one embodiment, at least one of, such as at least two of, such as all three of R₂₄, R₂₅, and R₂₆ may include an aryl. In particular, it may include a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In addition, in one embodiment, the aryl may be polycyclic. The polycyclic aryl may include fused, bridged, and spiro ring systems.

In one embodiment, R₂₄, R₂₅, and R₂₆ may all be the same. It should be understood that the substituent is the same substituent group and has the same length. For example, in one embodiment, R₂₄, R₂₅, and R₂₆ may all be alkyl, such as a C₅ alkyl. In another embodiment, however, R₂₄, R₂₅, and R₂₆ may be different. For instance, in one embodiment, all three R₂₄, R₂₅, and R₂₆ may be different. For instance, while they may have the same chemical formula, they may be isomers having a different structure or configuration. In another embodiment, at least two of R₂₄, R₂₅, and R₂₆ may be the same while the other is different. By different, it should be understood that the substituent is a different substituent group. For example, one of the groups may be an alkyl while another may be an alkenyl. Alternatively, as another example, at least two of the groups may be an alkyl wherein each alkyl has a different chain length.

As indicated above, m, n, and o are each independently from 0 to 3. For instance, m may be from 0 to 3, such as from 1 to 3, such as from 1 to 2. In this regard, in one embodiment, m may be 0. In another embodiment, m may be 1. In another embodiment, m may be 2. In a further embodiment, m may be 3. Similarly, n may be from 0 to 3, such as from 1 to 3, such as from 1 to 2. In this regard, in one embodiment, n may be 0. In another embodiment, n may be 1. In another embodiment, n may be 2. In a further embodiment, n may be 3. Further, o may be from 0 to 3, such as from 1 to 3, such as from 1 to 2. In this regard, in one embodiment, o may be 0. In another embodiment, o may be 1. In another embodiment, o may be 2. In a further embodiment, o may be 3.

Furthermore, in one embodiment, R₂₄, R₂₅, and R₂₆ may each independently be at the para position. For instance, when m, n, and o are each independently 1, R₂₄, R₂₅, and R₂₆ may each independently be at the para position. In another embodiment, R₂₄, R₂₅, and R₂₆ may each independently be at the ortho position. For instance, in one embodiment, when m, n, and o are each independently 1, R₂₄, R₂₅, and R₂₆ may each independently be at the ortho position. In another embodiment, when m, n, and o are each independently 2, R₂₄, R₂₅, and R₂₆ may each independently be at the para position and the ortho position.

In this regard, in one embodiment, m, n, and o may each be the same. For instance, in one embodiment, m, n, and o may be 1. Accordingly, in one embodiment, the organic phosphite antioxidant may have the following structure (II) wherein m, n, and o are each 1:

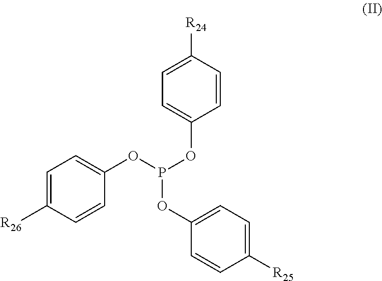

wherein,
R₂₄, R₂₅, and R₂₆ are as defined above.

In another embodiment, m, n, and o may be 2. In this regard, R₂₄, R₂₅, and R₂₆ may each independently be at the ortho and para positions. The organic phosphite antioxidant may have the following structure (III) wherein m, n, and o are each 2:

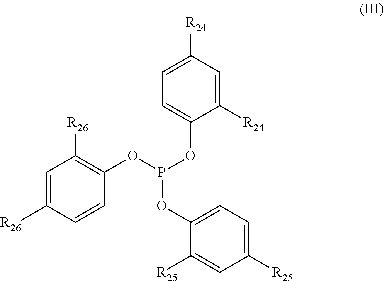

wherein,
R₂₄, R₂₅, and R₂₆ are as defined above.

In a further embodiment, m, n, and o may be 3. In this regard, R₂₄, R₂₅, and R₂₆ may each independently be at the two ortho and para positions.

In addition, it should be understood that in one embodiment, all three of m, n, and o may be different. For instance, at least one of m, n, and o may be 1, while another of m, n, and o may be 2, while another of m, n, and o may be 3.

In a further embodiment, at least two of m, n, and o may be the same while the other is different. For instance, at least two of m, n, and o may be 1 while the third may be 2 or 3, such as 2 in one embodiment or 3 in another embodiment. In this regard, the organic phosphite antioxidant may have the following structure (IV) wherein n and o are 1 and m is 2:

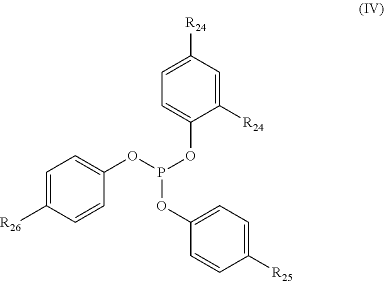

wherein,
R₂₄, R₂₅, and R₂₆ are as defined above.

Alternatively, at least two of m, n, and o may be 2 while the third may be 1 or 3, such as 1 in one embodiment or 3 in another embodiment. In this regard, the organic phosphite antioxidant may have the following structure (V) wherein m and n are 2 and o is 1:

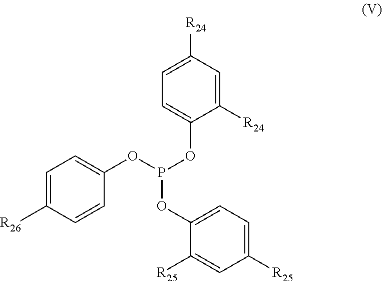

wherein,
R₂₄, R₂₅, and R₂₆ are as defined above.

In a further embodiment, at least two of m, n, and o may be 3 while the third may be 1 or 2, such as 1 in one embodiment or 2 in another embodiment.

In addition, it should be understood that any of the aforementioned organic phosphite antioxidants of structures (II), (III), (IV), or (V) may be utilized individually or in combination. For instance, at least one, such as at least two, such as at least three, such as at least all four of the aforementioned organic phosphite antioxidants of structures (II), (III), (IV), or (V) may be utilized.

While the aforementioned structures are utilized to depict the phosphite ester, in view of such structures, it should be understood that multiple phosphite esters may be utilized. For instance, multiple phosphite esters in accordance with the aforementioned structures and definitions may be utilized. For instance, the one or more organic phosphite antioxidants may be one or more, such as two or more phosphite esters.

In addition to the above, it should be understood that other organic phosphite antioxidants may also be utilized in accordance with the present disclosure. For instance, in one embodiment, at least one of the one or more organic phosphite antioxidants, such as the one or more phosphite esters, may be referred to as a pentaerythritol diphosphite. In this regard, the pentaerythritol diphosphite may have the following structure (XII):

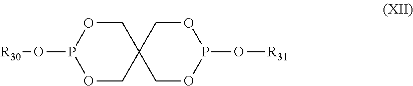

wherein
R₃₀ and R₃₁ are each independently an alkyl or an aryl.

In one embodiment, at least one of R₃₀ and R₃₁ may be alkyl. In another embodiment, both of R₃₀ and R₃₁ may be alkyl. In one embodiment, the alkyl may be an unsubstituted alkyl. In another embodiment, the alkyl may be a substituted alkyl. For instance, the alkyl may be an arylkyl (i.e., an alkyl substituted with an aryl group).

For instance, the alkyl may be a C₁-C₅₀ alkyl. In this regard, the alkyl may be a C₁-C₅₀ alkyl, such as a C₂-C₄₀ alkyl, such as a C₃-C₃₀ alkyl, such as a C₄-C₂₀ alkyl. For instance, the alkyl may have 1 or more, such as 2 or more, such as 3 or more, such as 4 or more, such as 5 or more, such as 8 or more, such as 10 or more, such as 14 or more, such as 18 or more, such as 20 or more, such as 24 or more, such as 28 or more, such as 30 or more, such as 34 or more, such as 38 or more, such as 40 or more, such as 44 or more carbon atoms. The alkyl may have 50 or less, such as 46 or less, such as 42 or less, such as 40 or less, such as 38 or less, such as 34 or less, such as 30 or less, such as 26 or less, such as 22 or less, such as 20 or less, such as 18 or less, such as 16 or less, such as 14 or less, such as 10 or less, such as 8 or less, such as 6 or less, such as 5 or less, such as 4 or less, such as 3 or less, such as 2 or less carbon atoms. In this regard, the alkyl may be octadecyl, hexadecyl, butyldecyl, dodecyl, decyl, nonyl, octyl, heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be methyl. In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

Regarding the substituted alkyl, it may be an arylkyl (i.e., an alkyl substituted with an aryl group) in one embodiment. The aryl may be a C₃-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

In another embodiment, the substituted alkyl may be substituted with an alkyl. Particularly, if the alkyl is a cycloalkyl, the cycloalkyl may have an alkyl substitution. The alkyl may be a C₁-C₁₀ alkyl. In this regard, the alkyl may be a C₁-C₁₀ alkyl, such as a C₁-C₈ alkyl, such as a C₁-C₆ alkyl, such as a C₂-C₆ alkyl, such as a C₄-C₆ alkyl, such as a C₅ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be pentyl (e.g., tert-amyl or tert-pentyl). In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

In one embodiment, at least one of R₃₀ and R₃₁ may be aryl. In another embodiment, both of R₃₀ and R₃₁ may be aryl. In one embodiment, the aryl may be an unsubstituted aryl. In another embodiment, the aryl may be a substituted aryl. For instance, the aryl may be an alkaryl (i.e., an aryl substituted with one or more alkyl groups).

For instance, the aryl may be a C₅-C₁₂ aryl. In this regard, the aryl may be a C₃-C₁₂ aryl, such as a C₄-C₁₂ aryl, such as a C₆-C₁₂ aryl, such as a C₆-C₁₀ aryl, such as a C₆-C₈ aryl, such as a C₆ aryl. For instance, the aryl may have 3 or more, such as 4 or more, such as 5 or more, such as 6 or more carbon atoms. The aryl may have 12 or less, such as 10 or less, such as 8 or less, such as 7 or less, such as 6 or less, such as 5 or less carbon atoms. In one particular embodiment, the aryl may be a phenyl. In addition, in one embodiment, the aryl may be polycyclic. The polycyclic aryl may include fused, bridged, and spiro ring systems.

Regarding the substituted aryl, it may be an alkaryl (i.e., an aryl substituted with one or more alkyl groups). The alkyl may be a C₁-C₁₀ alkyl. In this regard, the alkyl may be a C₁-C₁₀ alkyl, such as a C₁-C₈ alkyl, such as a C₁-C₆ alkyl, such as a C₂-C₆ alkyl, such as a C₄-C₆ alkyl, such as a C₅ alkyl. For instance, the alkyl may have 1 or more, such as 2 or more, such as 3 or more, such as 4 or more, such as 5 or more carbon atoms. The alkyl may have 10 or less, such as 8 or less, such as 6 or less, such as 5 or less, such as 4 or less, such as 3 or less, such as 2 or less carbon atoms. In this regard, the alkyl may be heptyl, hexyl, pentyl (e.g., n-pentyl, sec-pentyl, iso-pentyl, tert-pentyl, neo-pentyl), butyl (e.g., n-butyl, sec-butyl, iso-butyl, tert-butyl), propyl (e.g., n-propyl, iso-propyl), ethyl, methyl, etc. In one particular embodiment, the alkyl may be pentyl (e.g., tert-amyl or tert-pentyl). In addition, the alkyl may be a straight chain, a branched chain, or cyclic. In one embodiment, the alkyl is a straight chain. In another embodiment, the alkyl is a branched chain. In a further embodiment, the alkyl is cyclic (or cycloalkyl).

In one embodiment, one of R₃₀ and R₃₁ may be alkyl as defined above while the other of R₃₀ and R₃₁ may be aryl as defined above.

In addition to the above, other organic phosphite antioxidants may also be utilized in accordance with the present disclosure. These may include those phosphite esters, such as any of the above, having one or more caged atoms. In particular, such one or more caged atoms may be an oxygen atom within the structure of the phosphite antioxidant, particular the phosphite ester.

The organic phosphite antioxidant(s) may include, but is not limited to, bis(2,4,di-t-butylphenyl)pentaerythritol diphosphite (CAS 26741-53-7); 2,4,6-tri-tert-butylphenyl-2-butyl-2-ethyl-1,3-propanediol phosphite (CAS 161717-32-4); tris(2,4-di-t-butylphenyl)phosphite (CAS 31570-04-4); tetrakis(2,4-di-t-butylphenyl)4,4′-biphenylene diphosphonite (CAS 38613-77-3); tris(4-n-nonylphenyl)phosphite (CAS 26523-78-4); distearylpentaerythritol diphosphite (CAS 3806-34-6); distearylpentaerythritol diphosphite (w/<1 wt. % triisopropanolamine (TIPA)) (CAS 3806-34-6); triphenyl phosphite (CAS 101-02-0); bis(2,4-dicumylphenyl)pentaerythritol diphosphite (CAS 154862-43-8); phosphorous acid, mixed 2,4-bis(1,1-dimethylpropyl)phenyl and 4-(1,1-dimethylpropyl)phenyl triesters (CAS 939402-02-5); phosphorous acid, mixed 2,4-bis(1,1-dimethylpropyl)phenyl and 4-(1,1-dimethylpropyl)phenyl triesters (w/triisopropanolamine (TIPA)) (CAS 939402-02-5); tris(dipropyleneglycol) phosphite, C18H3909P (CAS 36788-39-3); poly(dipropylene glycol) phenyl phosphite (CAS 80584-86-7); diphenyl isodecyl phosphite, C₂₂H₃₁O₃P (CAS 26544-23-0); phenyl diisodecyl phosphite (CAS 25550-98-5); heptakis (dipropyleneglycol) triphosphite (CAS 13474-96-9); bis(2,6-di-tert-butyl-4-methylphenyl)pentaerythritol diphosphite (CAS 80693-00-1); tris(2-t-butylphenyl)phosphite (CAS 31502-36-0); trisphenyl phosphite; and/or compatible mixtures of two or more thereof.

In one embodiment, the organic phosphite antioxidant(s) may include bis(2,4,di-t-butylphenyl)pentaerythritol diphosphite (CAS 26741-53-7); tris(2,4-di-t-butylphenyl)phosphite (CAS 31570-04-4); distearylpentaerythritol diphosphite (CAS 3806-34-6); distearylpentaerythritol diphosphite (w/<1 wt. % triisopropanolamine) (CAS 3806-34-6); triphenyl phosphite (CAS 101-02-0); phosphorous acid, mixed 2,4-bis(1,1-dimethylpropyl)phenyl and 4-(1,1-dimethylpropyl)phenyl triesters (CAS 939402-02-5); phosphorous acid, mixed 2,4-bis(1,1-dimethylpropyl)phenyl and 4-(1,1-dimethylpropyl)phenyl triesters (w/triisopropanolamine (TIPA)) (CAS 939402-02-5); or a mixture thereof. In one particular embodiment, the organic phosphite antioxidant may include bis(2,4,di-t-butylphenyl)pentaerythritol diphosphite (CAS 26741-53-7). In another particular embodiment, the organic phosphite antioxidant(s) may include tris(2,4-di-t-butylphenyl)phosphite (CAS 31570-04-4). In a further particular embodiment, the organic phosphite antioxidant(s) may include distearylpentaerythritol diphosphite (CAS 3806-34-6). In another particular embodiment, the organic phosphite antioxidant(s) may include triphenyl phosphite (CAS 101-02-0).

In another particular embodiment, the organic phosphite antioxidant(s) may include at least phosphorous acid, mixed 2,4-bis(1,1-dimethylpropyl)phenyl and 4-(1,1-dimethylpropyl)phenyl triesters (CAS 939402-02-5). In certain embodiments, the aforementioned may be provided with TIPA. In this regard, the organic phosphite antioxidant(s) may include, but is not limited to, tris-4-tert-butyl phenyl phosphite, tris 2,4-di-tert-butyl phenyl phosphite, bis(4-tert-butylphenyl)-2,4-di-tert-butylphenyl phosphite, bis(2,4-di-tert-butylphenyl)-4-tert-butylphenyl phosphite, tris 4-tert-pentyl phenyl phosphite, tris 2,4-di-tert-pentyl phenyl phosphite, bis(4-tert-pentylphenyl)-2,4-di-tert-pentylphenyl phosphite, bis(2,4-di-tert-pentylphenyl)-4-tert-pentylphenyl phosphite, the like, as well as mixtures thereof.

In certain embodiments, the organic phosphite antioxidant(s) may include a mixture of phosphorous acid, mixed 2,4-bis(1,1-dimethylpropyl)phenyl and 4-(1,1-dimethylpropyl)phenyl triesters (CAS 939402-02-5) and bis(2,4,di-t-butylphenyl)pentaerythritol diphosphite (CAS 26741-53-7). In certain embodiments, the former may be provided with TIPA.

In certain embodiments, the organic phosphite antioxidant(s) may include a mixture of phosphorous acid, mixed 2,4-bis(1,1-dimethylpropyl)phenyl and 4-(1,1-dimethylpropyl)phenyl triesters (CAS 939402-02-5) and distearylpentaerythritol diphosphite (CAS 3806-34-6). In certain embodiments, the former may be provided with TIPA.

In certain embodiments, the organic phosphite antioxidant(s) may include a mixture of phosphorous acid, mixed 2,4-bis(1,1-dimethylpropyl)phenyl and 4-(1,1-dimethylpropyl)phenyl triesters (CAS 939402-02-5) and distearylpentaerythritol diphosphite (w/<1 wt. % triisopropanolamine (TIPA)) (CAS 3806-34-6). In certain embodiments, the former may be provided with TIPA.

The organic phosphite antioxidant(s) may have a certain molecular weight. For instance, the molecular weight may be 400 g/mol or more, such as 450 g/mol or more, such as 500 g/mol or more, such as 550 g/mol or more, such as 600 g/mol or more, such as 650 g/mol or more, such as 700 g/mol or more, such as 750 g/mol or more, such as 800 g/mol or more. The molecular weight may be 2,000 g/mol or less, such as 1,800 g/mol or less, such as 1,600 g/mol or less, such as 1,400 g/mol or less, such as 1,200 g/mol or less, such as 1,000 g/mol or less, such as 900 g/mol or less, such as 800 g/mol or less, such as 750 g/mol or less, such as 700 g/mol or less, such as 650 g/mol or less, such as 600 g/mol or less.

The organic phosphite antioxidant(s) may also have a certain phosphorus content. For instance, the phosphorus content may be 0.5 wt. % or more, such as 1 wt. % or more, such as 2 wt. % or more, such as 3 wt. % or more, such as 4 wt. % or more, such as 5 wt. % or more, such as 6 wt. % or more, such as 7 wt. % or more, such as 8 wt. % or more, such as 9 wt. % or more, such as 10 wt. % or more. The phosphorus content may be 20 wt. % or less, such as 18 wt. % or less, such as 16 wt. % or less, such as 14 wt. % or less, such as 12 wt. % or less, such as 10 wt. % or less, such as 8 wt. % or less, such as 6 wt. % or less, such as 5 wt. % or less, such as 4 wt. % or less.

The organic phosphite antioxidant(s) may also have a certain kinematic viscosity. For instance, the kinematic viscosity may be 11,000 mm²/s or less, such as 8,000 mm²/s or less, such as 7,500 mm²/s or less, such as 6,500 mm²/s or less, such as 5,500 mm²/s or less, such as 5,000 mm²/s or less, such as 3,000 mm²/s or less when measured at 30° C. The kinematic viscosity may be 1 mm²/s or more, such as 50 mm²/s or more, such as 100 mm²/s or more, such as 500 mm²/s or more, such as 1,000 mm²/s or more, such as 2,000 mm²/s or more, such as 3,000 mm²/s or more, such as 4,000 mm²/s or more when measured at 30° C. The viscosity may be determined using a glass capillary viscometer according to ASTM D445-19.

Furthermore, in one embodiment, the one or more organic phosphite antioxidants may be a liquid at ambient conditions (i.e., at atmospheric pressure and a temperature of 25° C.). By providing such organic phosphite antioxidant as a liquid, it may be easily combined with the polyester material and other components to form the melt-blended polyester composition as well as any other resulting compositions. In another embodiment, the organic phosphite antioxidant(s) may be a solid at ambient conditions (i.e., at atmospheric pressure and a temperature of 25° C.).

In addition, in one embodiment, the one or more organic phosphite antioxidants may have a melting point of 100° C. or less, such as 90° C. or less, such as 80° C. or less, such as 70° C. or less, such as 60° C. or less, such as 50° C. or less, such as 40° C. or less. The melting point may be determined using techniques in the art, such as differential scanning calorimetry (e.g., in accordance with ASTM E794-06 (2018)).

The one or more organic phosphite antioxidant(s) may be present in a respective composition in a particular amount. For instance, the one or more organic phosphite antioxidant(s) may be present in an amount of greater than 0 wt. %, such as about 0.01 wt. % or more, such as about 0.03 wt. % or more, such as about 0.05 wt. % or more, such as about 0.1 wt. % or more, such as about 0.15 wt. % or more, such as about 0.2 wt. % or more, such as about 0.3 wt. % or more, such as about 0.5 wt. % or more, such as about 1 wt. % or more, such as about 3 wt. % or more, such as about 5 wt. % or more, such as about 8 wt. % or more, such as about 10 wt. % or more based on the weight of the composition. The one or more organic phosphite antioxidant(s) may be present in an amount of about 10 wt. % or less, such as about 7 wt. % or less, such as about 5 wt. % or less, such as about 4 wt. % or less, such as about 3 wt. % or less, such as about 2.5 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.5 wt. % or less, such as about 0.3 wt. % or less, such as about 0.25 wt. % or less, such as about 0.2 wt. % or less, such as about 0.15 wt. % or less, such as about 0.1 wt. % or less based on the weight of the composition. In one embodiment, the aforementioned composition may refer to the melt-blended polyester composition. In another embodiment, the aforementioned composition may refer to the polycondensed polyester composition.

Further, it should be understood that the organic phosphite antioxidants may be present in the respective composition in the percentages mentioned above. In addition or alternatively, each individual organic phosphite antioxidant may be present in the respective composition in the percentages mentioned above.

Also, it should be understood that the organic phosphite antioxidant(s) may include a mixture of organic phosphite antioxidants. For instance, a respective composition may include at least one, such as at least two, such as at least three, such as at least four organic phosphite antioxidants. As an example, each of the organic phosphite antioxidant(s) may have a different number of substituent groups and/or different substituent groups as defined above.

Also, the amount of the organic phosphite antioxidant(s), individually or collectively, may be present in one respective composition in an amount different from another respective composition. For instance, in one embodiment, the organic phosphite antioxidant(s), individually or collectively, may be present in a first weight percentage in the melt-blended polyester composition. The organic phosphite antioxidant(s), individually or collectively, may be present in a second weight percentage in the polycondensed polyester composition. Due to hydrolysis of the organic phosphite antioxidant(s), the first weight percentage may be greater than the second weight percentage in one embodiment. In addition, in one embodiment, the aforementioned weight percentage may be based on the weight of the respective composition. In another embodiment, the aforementioned weight percentage may be based on the weight of the polyester (e.g., melt-blended polyester, polycondensed polyester) in the respective composition.

When providing the organic phosphite antioxidant(s) according to the method as described herein, it may be provided alone in one embodiment. For instance, the organic phosphite antioxidant(s) may not be mixed with any other additives.

However, in another embodiment, the organic phosphite antioxidant(s) may be provided with one or more additives. For instance, these additives may be those mentioned below or otherwise known in the art. While not limited, the additives may include a further antioxidant, an antiwear agent, a light stabilizer, an ultraviolet absorber, a lubricant, an acid scavenger, a clarifying agent, a nucleating agent, a metal deactivator (or metal chelator), a colorant, a flame retardant, a filler, a Lewis base, etc. as well as mixtures thereof. However, it should be understood that other additives may also be utilized.

In addition, these additives may be provided as a mixture or a blend. In particular, the additives may be provided as a non-dust blend. In this context, the term “non-dust blend” means substantially dust-free granules. For the avoidance of doubt, the term “granules” covers pellets, chips, flakes, tablets, pastilles, fragments, particles and the like. “Dust” in this context means material that passes through a sieve having 0.5 mm apertures. By “substantially dust-free,” it is meant that there is little or no dust present in the granules. For example, the amount of dust may be less than 15%, such as less than 10%, such as less than 5%, such as less than 3%, such as less than 1%, such as less than 0.5%, such as less than 0.1% by weight of the granules. Preferably, the amount of dust in the non-dust blend is less than about 1%, such as less than about 0.5%, such as less than about 0.1% by weight of the non-dust blend.

In one embodiment, the additive may include a polymer, such as a polyester. In particular, the polyester may be the same chemically as the polyester mentioned above with respect to the recycled polyester material. Such polyester additive may be a virgin polyester in one embodiment or a recycled polyester in another embodiment. As one example, in the instance the recycled polyester material comprises a polyethylene terephthalate, the polymer/polyester provided with the organic phosphite antioxidant(s) as the additive may also be a polyethylene terephthalate. Such polyethylene terephthalate may be a virgin polyethylene terephthalate and/or a recycled polyethylene terephthalate. In this regard, the organic phosphite antioxidant(s) may be provided as a masterbatch with the polyester to the process. In the masterbatch, the organic phosphite antioxidant(s) may be provided in an amount of 0.5 wt. % or more, such as 1 wt. % or more, such as 2 wt. % or more, such as 3 wt. % or more, such as 5 wt. % or more, such as 10 wt. % or more, such as 13 wt. % or more, such as 15 wt. % or more, such as 18 wt. % or more, such as 20 wt. % or more, such as 23 wt. % or more, such as 25 wt. % or more, such as 28 wt. % or more, such as 30 wt. % or more, such as 35 wt. % or more, such as 40 wt. % or more, such as 45 wt. % or more based on the weight of the masterbatch. The organic phosphite antioxidant(s) may be provided in an amount of 75 wt. % or less, such as 65 wt. % or less, such as 55 wt. % or less, such as 45 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less based on the weight of the masterbatch.

### Additives

In addition to the recycled polyester material and the one or more organic phosphite antioxidants, a respective composition may also include other additives. The additive(s) may be provided in order to impart a particular attribute or benefit to the respective composition. For instance, these may impact any combination of intrinsic viscosity, thermal stability, oxidative stability, hygroscopicity, color control, etc. Regardless, such additives may be optional in one embodiment.

In addition, such additives may be introduced to the melt blending apparatus when forming the melt blended polyester composition in one embodiment. In this regard, in one embodiment, such particular additives may also be present during the polycondensation step referenced herein and a resulting polycondensed polyester composition as defined herein. In another embodiment, such particular additives may be added to the polycondensed polyester composition after the polycondensation step.

These additives may include, but are not limited to, a dispersant, a detergent, an antiwear agent, a further antioxidant, a light stabilizer, an ultraviolet absorber, a lubricant, an acid scavenger, a clarifying agent, a nucleating agent, a friction modifier, a corrosion inhibitor, a metal deactivator (or metal chelator), a colorant, a flame retardant, an anti-static agent, an anti-block agent, a plasticizer, a filler, a Lewis base, a heat stabilizer, a dessicant, a hydrolytic stabilizer, a chain extender, etc. as well as mixtures thereof. When utilized, they may be present in a respective composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 4.5 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 15 wt. % or more, such as about 18 wt. % or more, such as about 20 wt. % or more based on the weight of the composition. They may be utilized in an amount of about 40 wt. % or less, such as about 38 wt. % or less, such as about 35 wt. % or less, such as about 33 wt. % or less, such as about 30 wt. % or less, such as about 27 wt. % or less, such as about 25 wt. % or less, such as about 23 wt. % or less, such as about 20 wt. % or less, such as about 17 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4.5 wt. % or less, such as about 4 wt. % or less, such as about 3.5 wt. % or less, such as about 3 wt. % or less, such as about 2.5 wt. % or less, such as about 2 wt. % or less, such as about 1.5 wt. % or less, such as about 1 wt. % or less, such as about 0.8 wt. % or less, such as about 0.6 wt. % or less, such as about 0.5 wt. % or less, such as about 0.4 wt. % or less, such as about 0.3 wt. % or less, such as about 0.1 wt. % or less based on the weight of the composition. In one embodiment, the aforementioned composition may refer to the melt-blended polyester composition. In another embodiment, the aforementioned composition may refer to the polycondensed polyester composition.

In one embodiment, such aforementioned weight percentages may be based on the weight of the recycled polyester material. In another embodiment, such aforementioned weight percentages may be based on the weight of the recycled polyester material and the organic phosphite antioxidant(s). In one particular embodiment, a respective additive may be present in a respective composition in an amount of 0 wt. %.

Such aforementioned weight percentages may apply to any single additive as mentioned herein in one embodiment. In another embodiment, such aforementioned weight percentages may apply to the combination of additives as mentioned herein.

In one embodiment, a respective composition may comprise a Lewis base. Such Lewis bases are generally known in the art. For instance, such Lewis bases may generally be referred to as electron donors. In this regard, they may include compounds including OH⁻, F⁻, H₂O, ROH, NH₃, SO₄²⁻, H—, CO, and the like. In one embodiment, the Lewis base may include a compound including an OH.

In one embodiment, the additive, such as the Lewis base, may comprise an alkanolamine. As generally understood in the art, alkanolamines contain both a hydroxyl group and an amino group on an alkane backbone. The alkanolamine may include, but is not limited to, a methanolamine, an ethanolamine, a propanolamine, or a mixture thereof. In one embodiment, the alkanolamine may be an ethanolamine, a propanolamine, or a mixture thereof. In a further embodiment, the alkanolamine may include a propanolamine.

Furthermore, the alkanolamine may be a monoalkanolamine, a dialkanolamine, a trialkanolamine, or a mixture thereof. In one embodiment, the alkanolamine may be a dialkanolamine, a trialkanolamine, or a mixture thereof. In a further embodiment, the alkanolamine may be a trialkanolamine. Examples of these alkanolamines may specifically include monoethanolamine, diethanolamine, triethanolamine, monoisopropanolamine, diisopropanolamine, triisopropanolamine, or a mixture thereof. In one particular embodiment, the alkanolamine may include triisopropanolamine. Other alkanolamines may include, but are not limited to, octyl-bis(2-ethanol)amine, nonyl-bis(2-ethanol)amine, decyl-bis(2-ethanolamine, undecyl-bis(2-ethanol)amine, dodecyl-bis(2-ethanol)amine, tridecyl-bis(2-ethanol)amine, tetradecyl-bis(2-ethanol)amine, pentadecyl-bis(2-ethanol)amine, hexadecyl-bis(2-ethanol)amine, heptadecyl-bis(2-ethanol)amine, octadecyl-bis(2-ethanol)amine, octyl-bis(2-propanol)amine, nonyl-bis(2-propanol)amine, decyl-bis(2-propanol)amine, undecyl-bis(2-propanol)amine, dodecyl-bis(2-propanol)amine, tridecyl-bis(2-propanol)amine, tetradecyl-bis(2-propanol)amine, pentadecyl-bis(2-propanol)amine, hexadecyl-bis(2-propanol)amine, heptadecyl-bis(2-propanol)amine, octadecyl-bis(2-propanol)amine, and mixtures thereof.

A respective composition may comprise a further antioxidant. For instance, the further antioxidant may comprise one or more of a phenolic antioxidant, a sulfur-containing antioxidant, an aminic antioxidant, an inorganic phosphite antioxidant, or a mixture thereof.

In one embodiment, the further antioxidant may comprise a phenolic antioxidant. Such phenolic antioxidant may be a fully hindered phenolic antioxidant, a partially hindered phenolic antioxidant, a low-hindered phenolic antioxidant, a non-hindered phenolic antioxidant, or a mixture thereof. Such terms “fully hindered,” “partially hindered,” “low-hindered,” and “non-hindered” are generally understood by one skilled in the art.

In this context, by “fully hindered” it is preferably meant that the phenolic antioxidant comprises substituent hydrocarbyl groups on both positions ortho to the phenolic —OH group, each of those substituent groups being branched at the C₁ and/or C₂ position, preferably at the C₁ position, with respect to the aromatic ring.

The fully hindered phenolic antioxidant, if present, may comprise tetrakismethylene (3,5-di-t-butyl-4-hydroxyhydrocinnamate) methane (CAS 6683-19-8); 2,2′thiodiethylene bis [3 (3,5-di-t-butyl hydroxyphenyl) propionate] (CAS 41484-35-9); octadecyl 3-(3′,5′-di-t-butyl-4′-hydroxyphenyl) propionate (CAS 2082-79-3); 1,3,5-tris(3,5-di-t-butyl-4-hydroxybenzyl) isocyanurate (CAS 27676-62-6); 1,3,5-trimethyl-2,4,6-tris(3,5-di-t-butyl-4-hydroxybenzyl)benzene (CAS 1709-70-2); N,N′-hexamethylenebis [3-(3,5-di-t-butyl-4-hydroxyphenyl) propionamide] (CAS 23128-74-7); 1,2-bis(3,5-di-t-butyl-4-hydroxyhydrocinnamoyl) hydrazine (CAS 32687-78-8); 2,2′-ethylidenebis [4,6-di-t-butylphenol] (CAS 35958-30-6); butylated hydroxytoluene (CAS 128-37-0); etc. and/or compatible mixtures of two or more thereof.

In this context, by “partially hindered” it is preferably meant that the phenolic antioxidant comprises at least one substituent hydrocarbyl group ortho to the phenolic —OH group, only one of the or each substituent group being branched at the C₁ and/or C₂ position, preferably at the C₁ position, with respect to the aromatic ring.

The partially hindered phenolic antioxidant, if present, may comprise 1,3,5-tris(4-tert-butyl-3-hydroxy-2,6-dimethylbenzyl)-1,3,5-triazine-2,4,6-(1H, 3H, 5H)-trione (CAS 40601-76-1); triethyleneglycol-bis-[3-(3-t-butyl-4-hydroxy-5-methylphenyl) propionate] (CAS 36443-68-2); the butylated reaction product of p-cresol and dicyclopentadiene (CAS 68610-51-5); 2,2′-methylenebis(6-t-butyl methylphenol) (CAS 119-47-1); ethylene bis[3,3-bis[3-(1,1-dimethylethyl)-4-hydroxyphenyl] butanoate] (CAS 32509-66-3); etc. and/or compatible mixtures of two or more thereof.

In this context, by “low hindered” it is preferably meant that the phenolic antioxidant comprises at least one substituent hydrocarbyl group ortho to the phenolic —OH group, none of those substituent groups being branched at the C₁ or C₂ position, preferably at the C₁ position, with respect to the aromatic ring.

In this context, by “non-hindered” it is preferably meant that the phenolic antioxidant comprises no substituent hydrocarbyl groups ortho to the phenolic-OH group.

A respective composition may include a sulfur-containing antioxidant. The sulfur-containing antioxidant may comprise one or more thioether groups. Without intending to be limited, the sulfur-containing antioxidant may have a sulfur group with the formula —CH₂—(S)ₓ—CH₂—, wherein x=1 or 2. In one embodiment, one or both of the —CH₂— groups is directly bonded to an aromatic group. In another embodiment, neither of the —CH₂— groups is directly bonded to an aromatic group. Particularly, in one embodiment, the sulfur-containing antioxidant may have the formula V—CH₂—(S)ₓ—CH₂—W, wherein x=1 or 2 and wherein V and W respectively may be the same or different and may be or contain an aliphatic group.

The sulfur-containing antioxidant may include, but is not limited to, 2,4-bis-(n-octylthio)-6-(4-hydroxy-3,5-di-tert-butylanilino)-1,3,5-triazine (CAS 991-84-4); 4,6-bis(octylthiomethyl)-o-cresol (CAS 110553-27-0); 2,2′thiodiethylene bis [3 (3,5-di-t-butyl-4-hydroxyphenyl) propionate] (CAS 41484-35-9); dilauryl thiodipropionate (CAS 123-28-4); distearyl thiodipropionate (CAS 693-36-7); ditridecylthiodipropionate (CAS 10595-72-9); pentaerythritol tetrakis (p-laurylthiopropionate) (CAS 29598-76-3); 2,4-bis(dodecylthiomethyl)-6-methylphenol (CAS 110675-26-8); distearyl-disulfide (CAS 2500-88-1); 4,4′-thiobis(2-tert-butyl-5-methylphenol) (CAS 96-69-5); 2,2′-thiobis(6-t-butyl-4-methylphenol) (CAS 90-66-4); etc. and/or compatible mixtures of two or more thereof.

The sulphur containing antioxidant may be an inorganic antioxidant in the sense that it may comprise a metal. In this regard, the sulphur containing antioxidant may comprise one or more of a metal thiosulphate, a metal bisulphite, a metal metabisulphite, a metal hydrosulphite, etc. and/or compatible mixtures of two or more thereof. The metal thiosulphate may be selected from compounds with the formula: M₂S₂O₃. The metal bisulphite may be selected from compounds with the formula: MHSO₃. The metal metabisulphite may be selected from compounds with the formula: M₂S₂O₅. The metal hydrosulphite may be selected from compounds with the formula: M₂S₂O₄. The aforementioned “M” may refer to a metal. Depending on the particular antioxidant, the metal may be an alkali metal and/or an alkaline earth metal. The alkali metal may be lithium (Li), sodium (Na), or potassium (K). The alkaline earth metal may be calcium (Ca) or magnesium (Mg).

A respective composition may include an aminic antioxidant. The aminic antioxidant may include, but is not limited to, acetone diphenylamine (CAS 68412-48-6); reaction products of diphenylamine and acetone (CAS 112-39-4); N,N′-diphenyl-p-phenylenediamine (CAS 74-31-7); benzeneamine, bis [4-(2-phenyl-2-propyl)phenyl] amine (CAS 10081-67-1); poly(1,2-dihydro-2,2,4-trimethylquinoline) (CAS 26780-96-1); dioctyldiphenylamine (CAS 101-67-7); 1,4-benzenediamine, N,N′-mixed phenyl and tolyl derivatives (CAS 68953-84-4); N,N′, N″-tris [4-[(1,4-dimethylpentyl)amino]phenyl]-1,3,5-triazine-2,4,6-triamine (CAS 121246-28-4); N-isopropyl-N′-phenyl-1,4-phenylenediamine (CAS 101-72-4); N-phenyl-, reaction products with 2,4,4-trimethylpentene (CAS 68411-46-1); N,N-bis-(1,4-dimethylpentyl)-p-phenylenediamine (CAS 3081-14-9); diphenylamine (CAS 122-39-4); (1,3-dimethylbutyl)-N′-phenyl-p-phenylenediamine (CAS 793-24-8); etc. and/or compatible mixtures of two or more thereof.

A respective composition may include an inorganic phosphite antioxidant. The inorganic phosphite antioxidant may comprise one or more of a metal phosphite, a metal hypophosphite, etc. and/or compatible mixtures of two or more thereof. The metal hypophosphite may be selected from compounds with the formula: MPO₂H₂. The aforementioned “M” may refer to a metal. Depending on the particular antioxidant, the metal may be an alkali metal and/or an alkaline earth metal. The alkali metal may be lithium (Li), sodium (Na), or potassium (K). The alkaline earth metal may be calcium (Ca) or magnesium (Mg). As one example, the inorganic phosphite antioxidant may be a metal hypophosphite. The metal hypophosphite may be sodium hypophosphite.

The metal hypophosphite may be in anhydrous form in one embodiment. Alternatively, the metal hypophosphite may be in hydrated form, such as a monohydrate metal hypophosphite.

A respective composition may include a UV stabilizer. The UV stabilizer may include a hindered amine light stabilizer and/or a UV absorber. The UV stabilizer may include, but is not limited to, butanedioic acid, 1,4-dimethyl ester, polymer with 4-hydroxy-2,2,6,6-tetramethyl-1-piperidineethanol (CAS 65447-77-0); bis(2,2,6,6-tetramethyl-4-piperidyl) sebacate (CAS 52829-07-9); poly [6-[(1,1,3,3-tetramethylbutyl)amino]-1,3,5-triazine-2,4-diyl] [2,2,6,6-tetramethyl-4-piperidiyl)imino]-1,6-hexanediyl [(2,2,6,6-tetramethyl-4-piperidiyl)imino]) (CAS 70624-18-9); 1,5,8,12-tetrakis [4,6-bis(N-butyl-N-1,2,2,6,6-pentamethyl piperidylamino)-1,3,5-triazin-2-yl]-1,5,8,12-tetraazadodecane (CAS 106990-43-6); bis(1,2,2,6,6-pentamethyl-4-piperidyl) sebacate (CAS 41556-26-7); salicylic acid derivatives such as phenyl salicylate, p-t-butyl salicylate, etc.; benzophenone system such as 2,4-dihydroxy benzophenone, 2-hydroxy-4-methoxybenzophenone, etc.; benzotriazole system such as 2-(2′-hydroxy-3′,5′-di-t-butylphenyl)benzotriazole, 2-(2′-hydroxy-3′-t-butyl-5′-methylphenyl)-5-chlorobenzotriazole, etc.; hindered amine system such as bis(2,2,6,6-tetramethyl-4-piperidyl) sebacate, dimethyl succinate-1-(2-hydroxyethyl)-4-hydroxy-2,2,6,6-tetramethyl piperidine condensation product; 2-hydroxybenzophenones, e.g. 2,4-dihydroxybenzophenone, 2-hydroxy-4-methoxybenzophenone, 2-hydroxy-4-octoxybenzophenone, and 5,5′-methylene bis(2-hydroxy-4-methoxybenzophenone); 2-(2′-hydroxyphenyl)benzotriazoles, e.g. 2-(2′-hydroxy-5′-methylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl)-5-chlorobenzotriazole, 2-(2′-hydroxy-3′,5′-dicumylphenyl)benzotriazole, and 2,2′-methylene bis(4-t-octyl-6-benzotriazolyl)phenol; benzoates, e.g. phenylsalicylate, resorcinol monobenzoate, 2,4-di-t-butylphenyl-3′,5′-di-t-butyl-4′-hydroxybenzoate, and hexadecyl-3,5-di-t-butyl-4-hydroxybenzoate; substituted oxanilides, e.g. 2-ethyl-2′-ethoxyoxanilide and 2-ethoxy-4′-dodecyloxanilide; cyanoacrylates, e.g. ethyl-α-cyano-β, β-diphenylacrylate and methyl-2-cyano-3-methyl-3-(p-methoxyphenyl) acrylate, etc. and/or compatible mixtures of two or more thereof

Additional examples of hindered amine light stabilizers include 2,2,6,6-tetramethyl-4-piperidylstearate, 1,2,2,6,6-pentamethyl-4-piperidylstearate, 2,2,6,6-tetramethyl-4-piperidylbenzoate, bis(2,2,6,6-tetramethyl-4-piperidylsebacate, bis(1,2,2,6,6-pentamethyl-4-piperidyl) sebacate, tetrakis(2,2,6,6-tetramethyl-4-piperidyl)-1,2,3,4-butane tetracarboxylate, tetrakis(1,2,2,6,6-pentamethyl-4-piperidyl)-1,2,3,4-butane tetracarboxylate, bis(1,2,2,6,6-pentamethyl-4-piperidyl)-di(tridecyl)-1,2,3,4-butane tetracarboxylate, bis(1,2,2,6,6-pentamethyl-4-piperidyl)-2-butyl-2-(3′,5′-di-t-butyl-4-hydroxybenzyl) malonate, 1-(2-hydroxyethyl)-2,2,6,6-tetramethyl-4-piperidinol/diethyl succinate polycondensate, 1,6-bis(2,2,6,6-tetramethyl-4-piperidylamino) hexane/dibromoethane polycondensate, 1,6-bis(2,2,6,6-tetramethyl-4-piperidylamino) hexane/2,4-dichloro-6-t-octyl amino-s-triazine polycondensate, 1,6-bis(2,2,6,6-tetramethyl-4-piperidylamino) hexane/2,4-dichloro-6-morphol ino-s-triazine polycondensate, etc. and/or compatible mixtures of two or more thereof. These mixtures may include any of the aforementioned UV stabilizers including those UV absorbers and hindered amine lights stabilizers mentioned above.

A respective composition may include an acid scavenger. The acid scavenger may include one or more of a metal oxide, a metal hydroxide, a metal carbonate, a metal carboxylate, and/or a metal salt. In one embodiment, the acid scavenger may comprise a metal carboxylate. The metal carboxylate may include a metal stearate and/or a metal lactate. In one embodiment, the metal carboxylate comprises a metal stearate. The metal stearate may include, but is not limited to, calcium stearate, zinc stearate, aluminum stearate, magnesium stearate, lithium stearate, sodium stearate, cadmium stearate, barium stearate and/or a mixture of two or more thereof. The metal lactate may include, but is not limited to, sodium lactate, magnesium lactate, calcium lactate, zinc lactate and/or a mixture of two or more thereof. In one embodiment, the acid scavenger may include a metal oxide. The metal oxide may include, but is not limited to, zinc oxide, magnesium oxide, titanium dioxide, etc. or a mixture thereof. In one embodiment, the acid scavenger may include a metal carbonate. The metal carbonate may include, but is not limited to, calcium carbonate, hydrotalcite, a hydrotalcite-like compound, or a mixture thereof.

A respective composition may include a metal deactivator (or metal chelator). The metal deactivator may include, but is not limited to, 1,2-bis(3,5-di-t-butyl-4-hydroxyhydrocinnamoyl) hydrazine (CAS 32687-78-8); 2,2′-oxamidobis [ethyl 3-(3,5-di-tert-butyl-4-hydroxyphenyl) propionate] (CAS 70331-94-1); ethylenediaminetetraacetic acid (EDTA); N,N′-diphenyloxalic acid diamide; N-salicylal-N′-salicyloylhydrazine; N,N′-bis-salicyloylhydrazine; salicyloylamino-1,2,4-triazole; bis-benzyliden-oxalic acid dihydrazide; as well as mixtures thereof. In one embodiment, the metal deactivator may include 1,2-bis(3,5-di-t-butyl-4-hydroxyhydrocinnamoyl) hydrazine (CAS 32687-78-8); 2,2′-oxamidobis [ethyl 3-(3,5-di-tert-butyl-4-hydroxyphenyl) propionate] (CAS 70331-94-1); ethylenediaminetetraacetic acid (EDTA); as well as mixtures thereof. In addition, non-limiting examples of suitable metal chelators include those of the crown ether type, cryptand, acidic, and amine type.

A respective composition may include a clarifying agent and/or a nucleating agent. In one embodiment, the stabilizer composition may include a clarifying agent. In another embodiment, the stabilizer composition may include a nucleating agent. In a further embodiment, the stabilizer composition may include a clarifying agent and a nucleating agent. These agents may include a metal benzoate and/or a sorbitol derivative. The metal benzoate, if present, may comprise sodium benzoate, magnesium benzoate, calcium benzoate, zinc benzoate and/or a mixture of two or more thereof. These agents may include bis(3,4-dimethylbenzylidene) sorbitol (CAS 135861-56-2); bis(4-propylbenzylidene) sorbitol (CAS 882073-43-0); 2,4,8,10-tetra(tert-butyl)-6-hydroxy-12H-dibenzo[d,g] [1,3,2]dioxaphosphocin 6-oxide, sodium salt (CAS 85209-91-2); and/or compatible mixtures of two or more thereof.

A respective composition may include a colorant. The colorant may include, but is not limited to, pigments, single pigment dispersions, dyes, talc filled resins, nano composites, coated micas, powdered aluminum and other metals, optical brighteners, fluorescents, phosphorescents, etc. as well as mixtures thereof.

In one embodiment, the colorant may include a pigment. The pigment may be an organic pigment, an inorganic pigment, or a mixture thereof. The organic pigment may include, but is not limited to, azo and disazo pigments such as azo and disazo lake, hansas, benzimidazolones, diarylides, pyrazolones, yellows and reds; polycyclic pigments such as phthalocyanines, quinacridones, perylenes, perinones, dioxazines, anthraquinones, isoindolins, thioindigo, diaryl or quinophthalone pigment, aniline black, or mixtures thereof. The inorganic pigment may include, but is not limited to, titanium oxide, titanium yellow, iron oxide, ultramarine blue, cobalt blue, chromic oxide green, lead yellow, cadmium yellow and cadmium red, carbon black pigments, and mixtures thereof. In one embodiment, the colorant may include carbon black. The organic and inorganic pigments can be used singly or in combination. These pigments may be in any form of a dry powder, pigment dispersions, or combinations thereof.

A respective composition may include a flame retardant. Such flame retardant is not limited by the present disclosure. The flame retardant may include, but is not limited to, phosphoric acid systems such as allyl diallyl phosphate, cresyl diphenyl phosphate, octyl diphenyl phosphate, triallyl phosphate, tributyl phosphate, triphenyl phosphate, tris(β-chloroethyl)phosphate, tris(dichloropropyl)phosphate, tris(2,3-dibrompropyl)phosphate, tris(bromo-chloropropyl)phosphate, etc., chlorine systems such as chlorinated paraffin, chlorinated polyphenyl, perchloropentacyclodecane, etc., bromine systems such as tetrabromoethane, tetrabromobutane, hexaborombenzene, decabromodiphenyloxide, polydibrornophenyloxide, bis(tribromophenoxy) ethane, ethylene bisbromonorbornane dicarboxylmide, ethylene bistetrabromophthalimide, etc. reaction type such as chlorendic acid anhydride, tetrabromo phthalic anhydride, tetrabromo bisphenol A, dietoxy-bis-(2-hydroxyethyl)-aminomethyl phosphate, dibormcresyl glycidyl ether, etc. as well as mixtures thereof.

A respective composition may include a filler. The filler may include, but is not limited to, glass filler (e.g., glass fibers, glass flakes, glass beads, etc.), talc, mica, clay, nano-clay, silica, or mixtures thereof. In one embodiment, the filler comprises a glass filler, such as glass fiber.

A respective composition may include a chain extender. The chain extender may be utilized to reverse any molecular weight damage caused by hydrolysis and/or modify the rheology to improve the melt strength of the polyester and corresponding composition. The chain extender is not necessarily limited and may include an anhydride (e.g., bis-anhydride such as pyromellitic dianhydride), a diepoxide, a bisoxazoline, phloretic phosphite oligomers, etc. In this regard, the chain extender is not necessarily limited by the present disclosure.

### Method

As indicated herein, the present disclosure is directed to a method of preparing a polyester. In particular, the method is directed to preparing a recycled polyester material, such as a recycled polyethylene terephthalate material. The method utilizes a combination of melt blending the recycled polyester material with one or more organic phosphite antioxidants as disclosed herein to form a melt-blended polyester composition. Thereafter, the melt-blended polyester composition is subjected to polycondensation providing a polycondensed polyester composition comprising a polycondensed polyester and the one or more organic phosphite antioxidants. The composition may also include a hydrolyzed derivative of at least one of the one or more organic phosphite antioxidants as further described herein. The polycondensation may be conducted via solid-state polymerization or liquid-state polymerization as generally known in the art. Due to such polycondensation, the resulting polycondensed polyester composition and resulting polycondensed polyester may exhibit an increased molecular weight and/or intrinsic viscosity greater than the molecular weight and/or intrinsic viscosity, respectively, of the recycled polyester material, the melt-blended polyester composition, and/or the melt-blended polyester.

Regarding the first step, the manner in which the melt blending occurs of the recycled polyester material and the one or more organic phosphite antioxidants is not necessarily limited by the present disclosure. The melt blending may occur in any melt blending apparatus generally utilized in the art. For instance, the melt blending apparatus may be any vessel that is suitable for blending the selected components or composition under temperature and shearing force conditions necessary to form a respective mixture of components. In this respect, the apparatus may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the apparatus is an extruder, which may be a single or multi-screw extruder. The term “multi-screw extruder” means an extruder having two or more screws; with two and three screw extruders being exemplary, and two or twin-screw extruders being preferred in some embodiments. The screws of the extruder may have a plurality of lobes; two and three lobe screws being preferred. It will readily be understood that other screw designs may be selected in accordance with the methods of embodiments of the present disclosure.

Before entering into the apparatus, any one or more of the components may be premixed using any mixing device generally known in the art. In the device, the one or more components may be added together and mixed or added individually at any point during the mixing process.

The melt-blended polyester composition may be formed in any suitable device using a variety of techniques as mentioned above. For instance, processing may include melt blending, in an apparatus, the recycled polyester material and the one or more organic phosphite antioxidants. In addition, to the extent included, any other additives may also be mixed or blended with the recycled polyester material and the one or more organic phosphite antioxidants.

In such process, the one or more organic phosphite antioxidants may be introduced in the apparatus before heating, during heating, and/or when the recycled polyester material has been heated and is already in a molten state. In one embodiment, the organic phosphite antioxidant(s) may be introduced with the recycled polyester material at ambient conditions and then provided to the apparatus. In another embodiment, the recycled polyester material may be provided to the apparatus and thereafter the organic phosphite antioxidant(s) may be introduced to the apparatus, either as a mixture or individually. For instance, at least a portion of the one or more organic phosphite antioxidants, or all the one or more organic phosphite antioxidants may be provided to the recycled polyester material after the recycled polyester material has been heated and in an at least partially molten state. Regardless, such organic phosphite antioxidant may be provided in a manner to allow for dispersion of the organic phosphite antioxidant(s) within the recycled polyester material.

In addition, one or more other additives, to the extent utilized, may be introduced in the apparatus before heating, during heating, and/or when the recycled polyester material has been heated and is already in a molten state. In one embodiment, the one or more other additives may be introduced with the recycled polyester material at ambient conditions and then provided to the apparatus. In another embodiment, the recycled polyester material may be provided to the apparatus and thereafter the one or more other additives may be introduced to the apparatus, either as a mixture or individually. For instance, at least a portion of the one or more other additives, or all the one or more other additives, may be provided to the recycled polyester material after the recycled polyester material has been heated and in an at least partially molten state. Regardless, such one or more other additives may be provided in a manner to allow for dispersion of the one or more additives within the recycled polyester material.

After melt blending, the melt-blended polyester composition may be discharged from the melt blending apparatus. In this regard, the melt-blended polyester composition may be milled, chopped, extruded, pelletized, or processed by any other desirable technique. Such forms may particularly be suitable for polycondensation conducted via solid-state polymerization. However, the melt-blended polyester composition may remain in a melt (or liquid) form particularly for conducting polycondensation via liquid-state polymerization.

After melt blending, the melt-blended polyester composition including the recycled polyester material and the one or more organic phosphite antioxidants is subjected to polycondensation for forming a polycondensed polyester composition comprising a polycondensed polyester. Such polycondensation may be conducted using means generally known in the art, such as solid-state polymerization or liquid-state polymerization. In one embodiment, the polycondensation may be conducted via solid-state polymerization. In another embodiment, the polycondensation may be conducted via liquid-state polymerization. Regardless of the approach, the polycondensation may be conducted before the melt-blended polyester composition is utilized to form a final article. In this regard, the melt-blended polyester composition may be utilized directly for polycondensation. However, it should be understood that a certain amount of time may lapse between the formation of the melt-blended polyester composition and initiation of the polycondensation.

In addition, the melt blending may be conducted in a first apparatus while the polycondensation may be conducted in a second apparatus. The second apparatus may be in-line with the first apparatus. For instance, such a configuration may be common when utilizing a liquid-state polymerization. Alternatively, the second apparatus may not be in-line with the first apparatus and instead may be offline. Such a configuration may be common when utilizing a solid-state polymerization.

Furthermore, the form of the melt-blended polyester composition for the polycondensation is not necessarily limited by the present disclosure. In this regard, the form of the melt-blended polyester composition may be dictated by whether the polycondensation may be conducted via solid-state polymerization or liquid-state polymerization. In this regard, in one embodiment, the melt-blended polyester composition may be in the form of pellets, chips, flakes, powder, etc. for polycondensation in one embodiment. In another embodiment, the melt-blended polyester composition may be in the form of a melt.

In general and without intending to be limited, the polycondensation is a polymerization reaction conducted to a solid phase (for solid-state polymerization) or a liquid phase (for liquid-state polymerization) of a polymer/oligomer at a temperature greater than the glass-transition temperature of the polymer/oligomer. For instance, the polycondensation may be conducted at a temperature between the glass-transition temperature of the polymer/oligomer and melting point of the polymer/oligomer.

The catalyst utilized for the polycondensation is not limited by the present disclosure. For instance, suitable catalysts may be identified in R. E. Wilfond in J. Polymer Sci., 54, 385-510 (1961) and W. Griehl and G. Schnock in J. Polymer Sci., 30, 413-422 (1958). The catalyst may include, but is not limited to, metal compounds such as alkoxide, acetylacetonate, oxide, complex, hydroxide or salt of organic acid of titanium, stibium, germanium, magnesium, calcium, zinc, ferrum, zirconium, lithium or manganese, etc. Some particular catalysts may include, but are not limited to, antimony trioxide, zinc acetate, tin oxalate, cohaltous acetate, lithium glycoloxide, germanium dioxide, stannous formate and tetrabutyl titanate, to name only a few. The concentration of the catalyst is not necessarily limited and may be 1 mmol/L or more, such as 5 mmol/L or more, such as 10 mmol/L or more, such as 25 mmol/L or more, such as 50 mmol/L or more, such as 100 mmol/L or more, such as 150 mmol/L or more, such as 200 mmol/L or more to 500 mmol/L or less, such as 400 mmol/L or less, such as 350 mmol/L or less, such as 300 mmol/L or less, such as 250 mmol/L or less, such as 200 mmol/L or less, such as 150 mmol/L or less, such as 125 mmol/L or less, such as 100 mmol/L or less, such as 80 mmol/L or less, such as 50 mmol/L or less. In addition, the catalyst may be provided at the appropriate position for assisting with the polycondensation in one embodiment. However, in one embodiment, it should be understood that a catalyst may not be utilized, particularly during polycondensation.

The polycondensation may be conducted at conditions suitable to allow for an increase in the molecular weight (also determined via intrinsic viscosity). In this regard, the time, temperature, and pressure for the polycondensation is not necessarily limited by the present disclosure but should be selected to allow for an increase in the molecular weight and/or the intrinsic viscosity of the recycled polyester material.

The polycondensation may be conducted at a desired temperature. In general, the temperature may be greater than the glass transition temperature of the recycled polyester material and/or melt-blended polyester. In addition, the temperature may be less than the melting temperature of the recycled polyester material and/or melt-blended polyester. Accordingly, the temperature may be greater than the glass transition temperature of the recycled polyester material and/or melt-blended polyester and less than the melting temperature of the recycled polyester material and/or melt-blended polyester. In one embodiment, the temperature may be greater than the melting temperature of the recycled polyester material. The temperature may be about 60° C. or more, such as about 80° C. or more, such as about 100° C. or more, such as about 120° C. or more, such as about 140° C. or more, such as about 160° C. or more, such as about 170° C. or more, such as about 180° C. or more, such as about 190° C. or more, such as about 200° C. or more, such as about 210° C. or more, such as about 220° C. or more, such as about 230° C. or more, such as about 240° C. or more. The temperature may be about 400° C. or less, such as about 380° C. or less, such as about 360° C. or less, such as about 340° C. or less, such as about 320° C. or less, such as about 300° C. or less, such as about 280° C. or less, such as about 260° C. or less, such as about 250° C. or less, such as about 240° C. or less, such as about 230° C. or less, such as about 220° C. or less, such as about 210° C. or less, such as about 200° C. or less, such as about 190° C. or less, such as about 180° C. or less, such as about 170° C. or less, such as about 160° C. or less, such as about 140° C. or less, such as about 120° C. or less, such as about 100° C. or less.

The polycondensation may be conducted at a desired pressure. For instance, the pressure may be about 0 torr or more, such as 0.01 torr or more, such as 0.02 torr or more, such as 0.05 torr or more, such as 0.1 torr or more, such as 0.2 torr or more, such as 0.3 torr or more, such as 0.5 torr or more, such as 1 torr or more, such as 2 torr or more, such as 3 torr or more, such as 4 torr or more, such as 5 torr or more, such as 10 torr or more, such as 15 torr or more, such as 20 torr or more, such as 25 torr or more. The pressure may be 50 torr or less, such as 40 torr or less, such as 30 torr or less, such as 25 torr or less, such as 20 torr or less, such as 15 torr or less, such as 13 torr or less, such as 10 torr or less, such as 9 torr or less, such as 8 torr or less, such as 7 torr or less, such as 6 torr or less, such as 5 torr or less, such as 4 torr or less, such as 3 torr or less, such as 2 torr or less, such as 1 torr or less, such as 0.5 torr or less. In one embodiment, the polycondensation may be conducted under vacuum.

The polycondensation may be conducted for a desired time. For instance, the time may be 0.5 hours or more, such as 1 hour or more, such as 2 hours or more, such as 3 hours or more, such as 4 hours or more, such as 6 hours or more, such as 8 hours or more, such as 10 hours or more, such as 12 hours or more, such as 16 hours or more, such as 20 hours or more, such as 24 hours or more, such as 28 hours or more, such as 32 hours or more, such as 36 hours or more. The time may be 48 hours or less, such as 44 hours or less, such as 40 hours or less, such as 36 hours or less, such as 32 hours or less, such as 28 hours or less, such as 24 hours or less, such as 20 hours or less, such as 16 hours or less, such as 12 hours or less, such as 10 hours or less, such as 8 hours or less, such as 6 hours or less, such as 4 hours or less.

The polycondensation may be conducted in a batch process or a continuous process. In one embodiment, the polycondensation may be conducted in a batch process. In another embodiment, the polycondensation may be conducted in a continuous process.

The polycondensation may be conducted in an inert gas. Some suitable inert gases may include, but are not limited to, nitrogen, carbon dioxide, helium, argon, neon, krypton, xenon, etc. Various combinations or mixtures of different inert gases can also be used. In one embodiment, the inert gas may be nitrogen. At the elevated temperature, transesterification and/or polycondensation reactions may proceed and the gas may be employed to carry away the volatile products (similar other methods, such as employing a vacuum, may be used for this purpose), thereby driving the molecular weight higher.

The polycondensation may allow for an increase in the molecular weight of the recycled polyester material and/or melt-blended polyester. In this regard, the molecular weight of the polycondensed polyester and corresponding polycondensed polyester composition may be higher than that of the recycled polyester material as well as the melt-blended polyester and corresponding melt-blended polyester composition.

The recycled polyester material and/or melt-blended polyester may have a particular weight average molecular weight prior to the polycondensation. The Mw may be about 5,000 g/mol or more, such as 10,000 g/mol or more, such as 15,000 g/mol or more, such as 20,000 g/mol or more, such as 25,000 g/mol or more, such as 30,000 g/mol or more, such as 40,000 g/mol or more, such as 50,000 g/mol or more, such as 60,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 200,000 g/mol or less, such as 100,000 g/mol or less, such as 80,000 g/mol or less, such as 50,000 g/mol or less, such as 40,000 g/mol or less, such as 30,000 g/mol or less, such as 20,000 g/mol or less. In general, the molecular weight may be characterized by GPC (gel permeation chromatography) using polystyrene standards.

The polycondensed polyester may have a particular weight average molecular weight after polycondensation. In particular, such molecular weight may be greater than the aforementioned molecular weight prior to the polycondensation. In this regard, the Mw may be about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less, such as 200,000 g/mol or less, such as 100,000 g/mol or less, such as 80,000 g/mol or less, such as 50,000 g/mol or less, such as 40,000 g/mol or less, such as 30,000 g/mol or less, such as 20,000 g/mol or less. In general, the molecular weight may be characterized by GPC (gel permeation chromatography) using polystyrene standards.

In addition, the polycondensation may also result in a higher intrinsic viscosity of the recycled polyester material and/or melt-blended polyester and/or melt-blended polyester composition. In this regard, the intrinsic viscosity of the polycondensed polyester and corresponding polycondensed polyester composition may be higher than that of the recycled polyester material as well as the melt-blended polyester and corresponding melt-blended polyester composition. In one embodiment, the intrinsic viscosity of the polycondensed polyester may be higher than that of the recycled polyester material. In another embodiment, the intrinsic viscosity of the polycondensed polyester may be higher than that of the melt-blended polyester. In a further embodiment, the intrinsic viscosity of the polycondensed polyester may be higher than that of the melt-blended polyester composition. In one embodiment, the intrinsic viscosity of the polycondensed polyester composition may be higher than that of the recycled polyester material. In another embodiment, the intrinsic viscosity of the polycondensed polyester composition may be higher than that of the melt-blended polyester. In a further embodiment, the intrinsic viscosity of the polycondensed polyester composition may be higher than that of the melt-blended polyester composition.

The recycled polyester material, melt-blended polyester material, and/or melt-blended polyester composition may have a first intrinsic viscosity. In one embodiment, the first intrinsic viscosity may be with respect to the recycled polyester material. In another embodiment, the first intrinsic viscosity may be with respect to the melt-blended polyester composition. The polycondensed polyester composition and/or the polycondensed polyester may have a second intrinsic viscosity. In one embodiment, the second intrinsic viscosity may be with respect to the polycondensed polyester composition. In general, the second intrinsic viscosity may be greater than the first intrinsic viscosity.

In this regard, the first intrinsic viscosity may be 0.2 dl/g or more, such as 0.25 dl/g or more, such as 0.3 dl/g or more, such as 0.35 dl/g or more, such as 0.4 dl/g or more, such as 0.45 dl/g or more, such as 0.5 dl/g or more, such as 0.55 dl/g or more, such as 0.6 dl/g or more, such as 0.65 dl/g or more, such as 0.7 dl/g or more, such as 0.75 dl/g or more, such as 0.8 dl/g or more. The first intrinsic viscosity may be 0.9 dl/g or less, such as 0.85 dl/g or less, such as 0.8 dl/g or less, such as 0.75 dl/g or less, such as 0.7 dl/g or less, such as 0.65 dl/g or less, such as 0.6 dl/g or less, such as 0.55 dl/g or less, such as 0.5 dl/g or less, such as 0.45 dl/g or less. The second intrinsic viscosity may be 0.5 dl/g or more, such as 0.55 dl/g or more, such as 0.6 dl/g or more, such as 0.65 dl/g or more, such as 0.7 dl/g or more, such as 0.75 dl/g or more, such as 0.8 dl/g or more, such as 0.85 dl/g or more, such as 0.9 dl/g or more, such as 0.95 dl/g or more, such as 1 dl/g or more, such as 1.05 dl/g or more, such as 1.1 dl/g or more, such as 1.15 dl/g or more, such as 1.2 dl/g or more. The second intrinsic viscosity may be 1.2 dl/g or less, such as 1.15 dl/g or less, such as 1.1 dl/g or less, such as 1.05 dl/g or less, such as 1 dl/g or less, such as 0.95 dl/g or less, such as 0.9 dl/g or less, such as 0.85 dl/g or less, such as 0.8 dl/g or less, such as 0.75 dl/g or less, such as 0.7 dl/g or less, such as 0.65 dl/g or less, such as 0.6 dl/g or less.

In one embodiment, the crystallinity of the polyester prior to undergoing polycondensation may be within a certain percentage. For instance, the crystallinity may be desired to be at least 15% crystalline, such as at least 20% crystalline, such as at least 25%, such as at least 30%, such as at least 35%. During solid-state conditions, the polyester may be semi-crystalline. For instance, the crystallinity may be 20% or more, such as 25% or more, such as 30% or more, such as 35% or more, such as 40% or more, such as 45% or more, such as 50% or more, such as 55% or more, such as 60% or more. The crystallinity may be 80% or less, such as 75% or less, such as 70% or less, such as 65% or less, such as 60% or less, such as 55% or less, such as 50% or less, such as 45% or less, such as 40% or less, such as 35% or less. The crystallinity may be determined at 150° C. after 4 hours.

In one embodiment, the crystallinity of the recycled polyester material may need to be increased prior to the polycondensation. Without intending to be limited, such increase in crystallinity may be necessary in order to raise the sticking temperature of the polyester material, particularly when conducting the polycondensation via solid-state polymerization.

If crystallization of the polyester is necessary prior to conducting the polycondensation, the method of crystallization is not necessarily limited. The crystallization can be conducted isothermally in one embodiment. In one embodiment, the crystallization can be conducted in air atmosphere, nitrogen atmosphere, or in vacuum. Alternatively, the crystallization may be conducted in a liquid medium, such as water. As one example, crystallization may be accomplished by relatively slowly cooling a polymer melt to room temperature. As another example, crystallization may be accomplished by controlled heating of a quenched polymer melt. As a further example, crystallization may be accomplished by treating a polymer with the vapor of a suitable organic solvent.

The solid-state polymerization technique is not necessarily limited by the present disclosure. In this regard, the solid-state polymerization techniques utilized in accordance with the present disclosure may be conducted using means generally known in the art. General examples are disclosed in various publications, including U.S. Pat. Nos. 6,160,085 and 7,205,379 and U.S. Application Publication No. 2005/272906, the contents of which are hereby incorporated by reference. However, it should be understood that the solid-state polymerization is not limited to such disclosures.

The liquid-state polymerization technique is not necessarily limited by the present disclosure. In this regard, the liquid-state polymerization techniques utilized in accordance with the present disclosure may be conducted using means generally known in the art. General examples are disclosed in various publications, including U.S. Application Publication Nos. 2022/0234331 and 2023/0093536, the contents of which are hereby incorporated by reference. However, it should be understood that the liquid-state polymerization is not limited to such disclosures.

Further, as indicated above, the recycled polyester material and melt-blended polyester composition are subject to polycondensation. Such polycondensation, as indicated herein, yields a polycondensed polyester composition including a polycondensed polyester and one or more organic phosphite antioxidants. In addition, as also indicated herein, the polycondensed polyester composition may also comprise a hydrolyzed derivative of at least one of the one or more organic phosphite antioxidants as further described herein.

For instance, during polycondensation, at least some of the organic phosphite antioxidant(s) may undergo hydrolysis. As the polycondensation occurs, the reaction yields water. The water may then react with the organic phosphite antioxidant(s) resulting in hydrolysis of the organic phosphite antioxidant(s). Generally, the hydrolysis of the antioxidant is undesirable as it may negatively impact the antioxidant performance of the antioxidant and the resulting composition. However, while the organic phosphite antioxidant(s) may become hydrolyzed during polycondensation, such hydrolysis may have the added benefit of the removal of water thereby allowing for the polymerization and polycondensation to proceed in a favorable direction. For instance, the presence of water generally negatively influences the polycondensation.

In general, the hydrolyzed derivative of the organic phosphite antioxidant(s) is the phosphite product of the reaction between the organic phosphite antioxidant(s) and water. In one particular embodiment wherein the organic phosphite antioxidant(s) is a phosphite ester, the hydrolyzed derivative of the organic phosphite antioxidant(s) is the phosphite product of the reaction between the phosphite ester and water. In general, for such reactions, a substituent group, such as an R group as mentioned above, may be cleaved and replaced with a hydrogen. In particular, an —OR group as mentioned above, may then become an —OH group upon hydrolysis and the reaction with water.

As indicated above, the organic phosphite antioxidant(s) may be a phosphite ester. The phosphite ester may have the general formula of structure (VI) as mentioned above. However, upon hydrolysis, examples of such a hydrolyzed derivative may include the structures (VIII) and/or (IX) as follows:

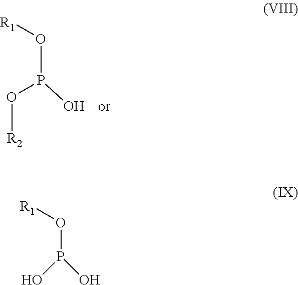

wherein
R₁ and R₂ are as defined above.

In particular, the hydrolyzed derivative may have at least one of the structures (X) and/or (XI) as follows wherein R₁ and R₂ are each aryl:

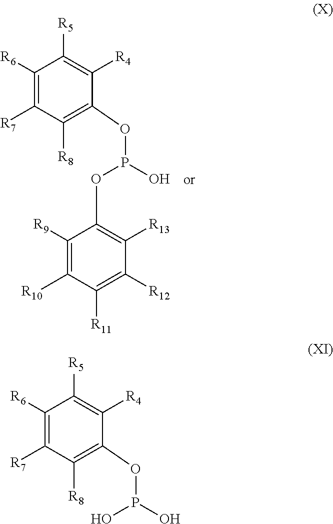

wherein
R₄, R₅, R₆, R₇, R₈, R₉, R₁₀, R₁₁, R₁₂, and R₁₃ are as defined above.

While the aforementioned structures are utilized to depict certain versions of the hydrolyzed derivative, it should be understood that other types of hydrolyzed derivatives may also be present within the composition. Regardless, such hydrolyzed derivative is formed from the reaction of the organic phosphite antioxidant(s) and water. In addition, the composition may include a mixture of hydrolyzed derivatives.

The amount of the hydrolyzed derivative of the organic phosphite antioxidant(s) may be may be about 10 wt. % or less, such as about 8 wt. % or less, such as about 6 wt. % or less, such as about 5 wt. % or less, such as about 4 wt. % or less, such as about 3 wt. % or less, such as about 2.5 wt. % or less, such as about 2 wt. % or less, such as about 1.8 wt. % or less, such as about 1.5 wt. % or less, such as about 1.3 wt. % or less, such as about 1.1 wt. % or less, such as about 1 wt. % or less, such as about 0.8 wt. % or less, such as about 0.5 wt. % or less, such as about 0.3 wt. % or less. The amount of the hydrolyzed derivative of the organic phosphite antioxidant(s) may be 0 wt. % or more, such as about 0.1 wt. % or more, such as about 0.3 wt. % or more, such as about 0.5 wt. % or more, such as about 0.8 wt. % or more, such as about 1 wt. % or more, such as about 1.3 wt. % or more, such as about 1.5 wt. % or more, such as about 2 wt. % or more. Such aforementioned weight percentages may be based on the weight of the polycondensed polyester composition in one embodiment. In another embodiment, such aforementioned weight percentages may be based on the weight of the polycondensed polyester.

In addition, the amount of the organic phosphite antioxidant(s) utilized in the melt-blended polyester composition actually hydrolyzed may be within a certain percentage. For instance, 1 wt. % or more, such as 2 wt. % or more, such as 3 wt. % or more, such as 4 wt. % or more, such as 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more of the organic phosphite antioxidant(s) may be hydrolyzed. The amount of the organic phosphite antioxidant(s) that may be hydrolyzed may be 95 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 25 wt. % or less, such as 20 wt. % or less, such as 15 wt. % or less, such as 10 wt. % or less.

### Polycondensed Polyester Composition

The present disclosure may also be directed to a polyester composition. For instance, such polyester composition may be the polycondensed polyester composition comprising a polyester and one or more organic phosphite antioxidants. In certain embodiments, the composition may also include a hydrolyzed derivative of at least one of the one or more organic phosphite antioxidants. In embodiments wherein the composition comprises at least two organic phosphite antioxidants, the composition may comprise a hydrolyzed derivative of at least two of the at least two organic phosphite antioxidants.

The polyester may be the polycondensed polyester mentioned herein. Further, the type of polyester may be the same as mentioned above with respect to the recycled polyester material. For instance, the ranges/definitions provided above with respect to such polyester material may apply to the polyester within the polycondensed polyester composition. However, it should be understood that such polycondensed polyester may have a different molecular weight and/or intrinsic viscosity as mentioned above.

The polycondensed polyester composition may generally comprise about 50 wt. % or more, such as about 60 wt. % or more, such as about 70 wt. % or more, such as about 80 wt. % or more, such as about 85 wt. % or more, such as about 90 wt. % or more, such as about 93 wt. % or more, such as about 95 wt. % or more, such as about 97 wt. % or more, such as about 98 wt. % or more, such as about 99 wt. % or more of the polyester (e.g., one or more polyesters) based on the weight of the composition. The composition may comprise about 99.99 wt. % or less, such as about 99.9 wt. % or less, such as about 99.8 wt. % or less, such as about 99.5 wt. % or less, such as about 99 wt. % or less, such as about 98 wt. % or less, such as about 97 wt. % or less, such as about 96 wt. % or less, such as about 95 wt. % or less, such as about 93 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less of the polyester (e.g., one or more polyesters) based on the weight of the composition.

The one or more organic phosphite antioxidant(s) may be present in the polycondensed polyester composition in a particular amount. For instance, the one or more organic phosphite antioxidant(s) may be present in an amount of about 0.01 wt. % or more, such as about 0.03 wt. % or more, such as about 0.05 wt. % or more, such as about 0.1 wt. % or more, such as about 0.15 wt. % or more, such as about 0.2 wt. % or more, such as about 0.3 wt. % or more, such as about 0.5 wt. % or more, such as about 1 wt. % or more, such as about 3 wt. % or more, such as about 5 wt. % or more, such as about 8 wt. % or more, such as about 10 wt. % or more, such as about 12 wt. % or more, such as about 15 wt. % or more, such as about 18 wt. % or more, such as about 20 wt. % or more, such as about 22 wt. % or more, such as about 25 wt. % or more, such as about 28 wt. % or more, such as about 30 wt. % or more based on the weight of the composition. The one or more organic phosphite antioxidant(s) may be present in an amount of about 40 wt. % or less, such as about 38 wt. % or less, such as about 35 wt. % or less, such as about 33 wt. % or less, such as about 30 wt. % or less, such as about 27 wt. % or less, such as about 25 wt. % or less, such as about 23 wt. % or less, such as about 20 wt. % or less, such as about 17 wt. % or less, such as about 15 wt. % or less, such as about 13 wt. % or less, such as about 10 wt. % or less, such as about 7 wt. % or less, such as about 5 wt. % or less, such as about 4 wt. % or less, such as about 3 wt. % or less, such as about 2.5 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.5 wt. % or less, such as about 0.3 wt. % or less, such as about 0.25 wt. % or less, such as about 0.2 wt. % or less, such as about 0.15 wt. % or less, such as about 0.1 wt. % or less based on the weight of the composition.

The hydrolyzed derivative of the organic phosphite antioxidant(s) may be present in the polycondensed polyester composition in a particular amount. The amount of the hydrolyzed derivative of the organic phosphite antioxidant(s) may be may be about 10 wt. % or less, such as about 8 wt. % or less, such as about 6 wt. % or less, such as about 5 wt. % or less, such as about 4 wt. % or less, such as about 3 wt. % or less, such as about 2.5 wt. % or less, such as about 2 wt. % or less, such as about 1.8 wt. % or less, such as about 1.5 wt. % or less, such as about 1.3 wt. % or less, such as about 1.1 wt. % or less, such as about 1 wt. % or less, such as about 0.8 wt. % or less, such as about 0.5 wt. % or less, such as about 0.3 wt. % or less based on the weight of the composition. The amount of the hydrolyzed derivative of the organic phosphite antioxidant(s) may be 0 wt. % or more, such as about 0.1 wt. % or more, such as about 0.3 wt. % or more, such as about 0.5 wt. % or more, such as about 0.8 wt. % or more, such as about 1 wt. % or more, such as about 1.3 wt. % or more, such as about 1.5 wt. % or more, such as about 2 wt. % or more based on the weight of the composition.

In addition, as mentioned above, additives may also be utilized in the polycondensed polyester composition. Such additives may be provided during melt-blending, polycondensation, or post-polycondensation. Regardless, they may include the additives generally known in the art as well as those mentioned above. In addition, they may be provided within the composition in the amounts mentioned above.

### Recycled Polyester Article

Once the polycondensed polyester composition, including the polycondensed polyester and the organic phosphite antioxidant, is formed, it may be utilized to form an article. In one embodiment, the polycondensed polyester composition may be utilized as is in forming an article. In another embodiment, the polycondensed polyester composition may be combined with any one or more additives prior to forming an article. Such additives may include any of those mentioned above in one embodiment.

In one embodiment, such additives may include a second polyester. For instance, the polycondensed polyester composition and resulting polycondensed polyester may be combined with a second polyester, such as a virgin polyester. The second polyester may be any polyester generally. For instance, the second polyester may be a polyester mentioned above with respect to the recycled polyester material. In another embodiment, the second polyester may be another polycondensed polyester and/or corresponding composition. In a further embodiment, the second polyester may be a virgin polyester and/or corresponding composition. In other embodiments, the second polyester may be any combination of the aforementioned. In this regard, the polycondensed polyester composition and resulting polycondensed polyester may be combined with the second polyester in certain amounts. For instance, the polycondensed polyester composition may be present in an amount of 1 wt. % or more, such as 2 wt. % or more, such as 3 wt. % or more, such as 5 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the combined weight of the polycondensed polyester composition and the second polyester. The polycondensed polyester composition may be present in an amount of less than 100 wt. %, such as 99 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 5 wt. % or less based on the combined weight of the polycondensed polyester composition and the second polyester.

Regardless, the resulting composition may be utilized to form an article. For instance, the resulting composition can be re-melted and re-processed to form an article. The composition may be shaped into the form of an article using any of a variety of techniques as is known in the art. For instance, the composition can advantageously be fabricated by employing typical molding processes, such as injection molding, extrusion molding, compression molding, blow molding, rotational molding, overmolding, etc. In general, these processes include heating the composition to a temperature that is equal to or in excess of the melt temperature of the polyester to form a pre-form for a mold cavity to then form the article, cooling the article to a temperature at or below the crystallization temperature of the polyester, and releasing the article from a mold. The mold cavity defines the shape of the article. The process may include extrusion molding in one embodiment. In this regard, the composition may be extruded. Upon exiting the extruder, the composition may be formed or shaped to a desired article. Such article may be formed by using a particular die to shape the composition as it exits the extruder. Such shaping/forming process, such as the extrusion process, may be an automated or robotic process. In another embodiment, the process may include blow molding. In a further embodiment, the process may include injection molding.

The composition as disclosed herein may be utilized in a variety of applications and such applications are not limited by the present disclosure. For instance, the article may include a beverage container (e.g., bottle), a textile, a container, etc. The composition may also be utilized to form filaments, films, fibers, or sheets that may be utilized for a variety of applications.

In one embodiment, the application may be a non-food contact application. In another embodiment, the application may be a food contact application. In this regard, the composition may be utilized for a container or packaging related to food or beverages. For instance, in one particular embodiment, the article may be a bottle, such as for water, soda, or other liquids. In such embodiments for food contact, the amount of the organic phosphite antioxidant utilized according to the present disclosure may be less than non-food contact applications.

### EXAMPLES

### Test Methods

Intrinsic Viscosity (I.V.): The intrinsic viscosity may be determined in accordance with ASTM D4603-18.

CIELAB Color: The values for L*, a*, and b* may be determined in accordance with PET-S-09 (revision date Sep. 3, 2024) of The Association of Plastic Recyclers.

Yellowness Index: The yellowness index (YI) was determined in accordance with ASTM E313-20.

### Example 1

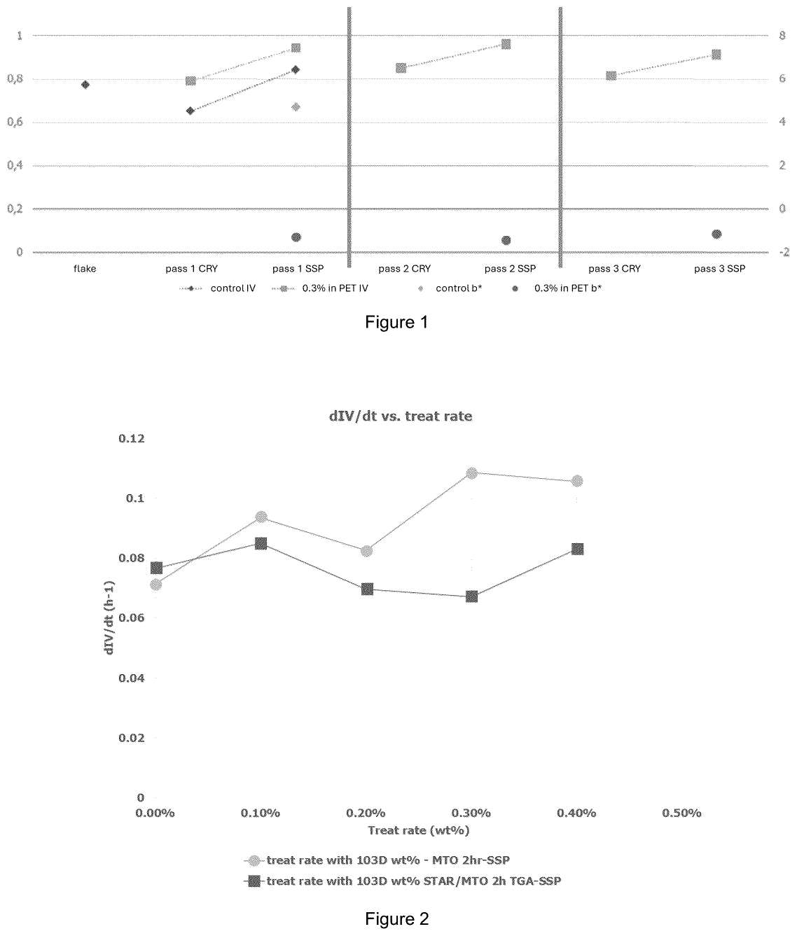

A polycondensed polyester composition was formed using phosphorous acid, mixed 2,4-bis(1,1-dimethylpropyl)phenyl and 4-(1,1-dimethylpropyl)phenyl triesters (w/triisopropanolamine) as the organic phosphite antioxidant in an amount of 0.3 wt. % with recycled polyethylene terephthalate. FIG. 1 illustrates the increase in the intrinsic viscosity and a decrease in the b* value of the polycondensed polyester composition including the organic phosphite antioxidant compared to the control samples.

### Example 2

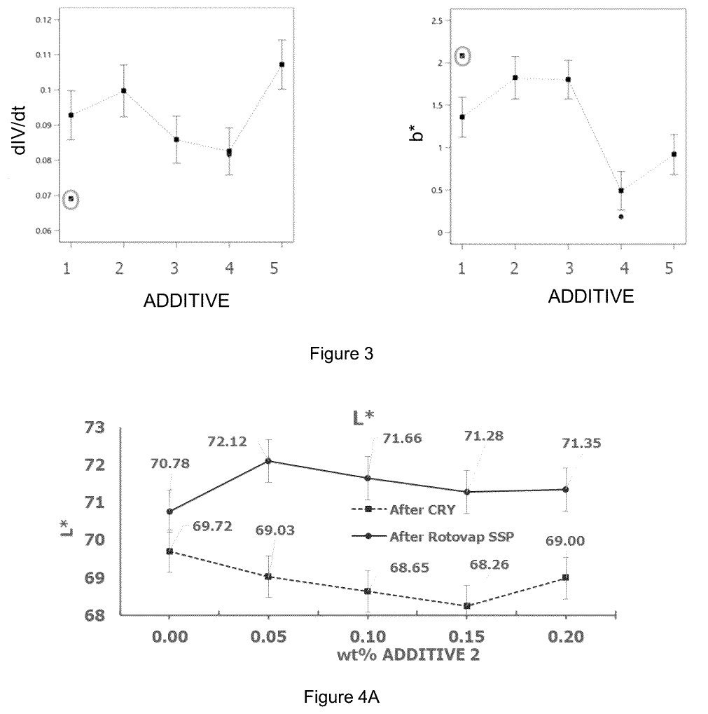

A polycondensed polyester composition was formed using phosphorous acid, mixed 2,4-bis(1,1-dimethylpropyl)phenyl and 4-(1,1-dimethylpropyl)phenyl triesters (w/triisopropanolamine) as the organic phosphite antioxidant in an amount of from 0 wt. % to 0.40 wt. % with recycled polyethylene terephthalate. The MTO 2 hr-SSP sample was prepared on a 16 mm twin-screw extruder and the STAR/MTO 2h TGA-SSP sample was prepared on a commercial STARLINGER recoSTAR. Both samples were subjected to 2 hours SSP under controlled conditions in a TGA instrument with an over temperature at 230° C. under a continuous nitrogen sweep. FIG. 2 illustrates the change in intrinsic viscosity of the samples over the two-hour period.

### Example 3

A polycondensed polyester composition was formed using an organic phosphite antioxidant and one or more of a metal chelator, a hindered phenolic antioxidant, and an acid scavenger. The color profile and the intrinsic viscosity of each composition was determined. The polycondensation may be conducted via liquid-state polymerization at a temperature of from 260° C.-300° C. or solid-state polymerization at a temperature of from 200° C.-240° C. In addition, the polycondensation may be conducted under vacuum or nitrogen gas.

The organic phosphite antioxidant was selected from the following: bis(2,4,di-t-butylphenyl)pentaerythritol diphosphite (CAS 26741-53-7) (“OP1”); tris(2,4-di-t-butylphenyl)phosphite (CAS 31570-04-4) (“OP2”); distearylpentaerythritol diphosphite (w/<1 wt. % triisopropanolamine) (CAS 3806-34-6) (“OP3”); triphenyl phosphite (CAS 101-02-0) (“OP4”); and phosphorous acid, mixed 2,4-bis(1,1-dimethylpropyl)phenyl and 4-(1,1-dimethylpropyl)phenyl triesters (w/TIPA) (CAS 939402-02-5) (“OP5”).

The metal chelator was selected from the following: 1,2-bis(3,5-di-t-butyl-4-hydroxyhydrocinnamoyl) hydrazine (CAS 32687-78-8) (“MC1”); 2,2′-oxamidobis [ethyl 3-(3,5-di-tert-butyl-4-hydroxyphenyl) propionate] (CAS 70331-94-1) (“MC2”); and ethylenediaminetetraacetic acid (EDTA) (“MC3”).

The hindered phenolic antioxidant was selected from the following: 1,3,5-tris(3,5-di-t-butyl-4-hydroxybenzyl) isocyanurate (CAS 27676-62-6) (“HP1”); 1,3,5-trimethyl-2,4,6-tris(3,5-di-t-butyl-4-hydroxybenzyl)benzene (CAS 1709-70-2) (“HP2”); tetrakismethylene (3,5-di-t-butyl-4-hydroxyhydrocinnamate) methane (CAS 6683-19-8) (“HP3”); and octadecyl 3-(3′,5′-di-t-butyl-4′-hydroxyphenyl) propionate (CAS 2082-79-3) (“HP4”).

The acid scavenger was selected from magnesium aluminum hydrotalcite (DHT).

In the examples below, the total amount of each additive package for a given run was 3000 ppm. The organic phosphite antioxidant was utilized in an amount of 2100 ppm with acid scavenger and 2333.33 ppm without acid scavenger. The metal chelator was utilized in an amount of 150 ppm with acid scavenger and 166.67 ppm without acid scavenger. The hindered phenolic antioxidant was utilized in an amount of 450 ppm with acid scavenger and 500 ppm without acid scavenger. The acid scavenger was utilized in an amount of 300 ppm with acid scavenger.

The sample information is as follows:

| | Organic | | | |
|---|---|---|---|---|
| | Phosphite | Metal | Hindered | Acid |
| Run | AO | Chelator | Phenolic AO | Scavenger |
| 1 | OP2 | MC2 | HP4 | — |
| 2 | OP2 | MC1 | HP3 | DHT |
| 3 | OP4 | MC3 | HP3 | DHT |
| 4 | OP3 | MC2 | HP2 | DHT |
| 5 | OP2 | MC1 | HP3 | DHT |
| 6 | OP1 | MC3 | HP2 | DHT |
| 7 | OP1 | MC1 | HP4 | DHT |
| 8 | OP2 | MC3 | HP1 | — |
| 9 | OP5 | MC1 | HP2 | — |
| 10 | OP3 | MC3 | HP4 | — |
| 11 | OP2 | MC3 | HP1 | — |
| 12 | OP4 | MC2 | HP1 | DHT |
| 13 | OP3 | MC1 | HP1 | DHT |
| 14 | OP4 | MC1 | HP2 | — |
| 15 | OP4 | MC1 | HP2 | — |
| 16 | OP3 | MC1 | HP3 | — |
| 17 | OP3 | MC2 | HP2 | DHT |
| 18 | OP1 | MC2 | HP3 | — |
| 19 | OP5 | MC3 | HP4 | DHT |
| 20 | OP1 | MC2 | HP3 | — |
| 21 | OP5 | MC2 | HP1 | — |

The results are provided in the table below:

| Run | L* | a* | b* | YI |
|---|---|---|---|---|
| 1 | 68.363 | −1.712 | 1.269 | 1.695 |
| 2 | 68.889 | −1.725 | 1.688 | 2.729 |
| 3 | 66.602 | −1.617 | 0.513 | −0.144 |
| 4 | 68.390 | −1.965 | 0.559 | −0.375 |
| 5 | 67.264 | −1.995 | 1.856 | 2.924 |
| 6 | 68.313 | −2.165 | 0.908 | 0.312 |
| 7 | 68.351 | −2.250 | 1.235 | 1.059 |
| 8 | 67.928 | −1.687 | 2.222 | 4.147 |
| 9 | 67.357 | −1.882 | 2.083 | 3.618 |
| 10 | 68.894 | −1.900 | 0.600 | −0.201 |
| 11 | 68.388 | −1.891 | 1.977 | 3.301 |
| 12 | 66.918 | −1.773 | 0.908 | 0.723 |
| 13 | 68.176 | −2.023 | 0.183 | −1.407 |
| 14 | 67.019 | −1.774 | 0.883 | 0.657 |
| 15 | 67.958 | −1.881 | 1.373 | 1.795 |
| 16 | 68.807 | −1.864 | 0.328 | −0.860 |
| 17 | 68.505 | −2.252 | 0.784 | −0.092 |
| 18 | 68.890 | −1.872 | 1.771 | 2.785 |
| 19 | 68.687 | −1.865 | 1.660 | 2.520 |
| 20 | 69.219 | −2.023 | 1.522 | 2.000 |
| 21 | 67.878 | −2.032 | 1.729 | 2.546 |

| Run | IV-SSP | IV-COMP | dIV/dt |
|---|---|---|---|
| 1 | 0.818 | 0.644 | 0.087 |
| 2 | 0.786 | 0.626 | 0.080 |
| 3 | 0.871 | 0.631 | 0.120 |
| 4 | 0.827 | 0.643 | 0.092 |
| 5 | 0.798 | 0.635 | 0.082 |
| 6 | 0.826 | 0.625 | 0.101 |
| 7 | 0.827 | 0.641 | 0.093 |
| 8 | 0.832 | 0.631 | 0.101 |
| 9 | 0.835 | 0.637 | 0.099 |
| 10 | 0.782 | 0.634 | 0.074 |
| 11 | 0.799 | 0.639 | 0.080 |
| 12 | 0.834 | 0.630 | 0.102 |
| 13 | 0.805 | 0.642 | 0.082 |
| 14 | 0.843 | 0.647 | 0.098 |
| 15 | 0.852 | 0.635 | 0.109 |
| 16 | 0.775 | 0.643 | 0.066 |
| 17 | 0.832 | 0.634 | 0.099 |
| 18 | 0.807 | 0.625 | 0.091 |
| 19 | 0.837 | 0.635 | 0.101 |
| 20 | 0.807 | 0.634 | 0.087 |
| 21 | 0.838 | 0.640 | 0.099 |

The tables above provide the measured values for L*, a*, b*, and YI and the values for IV-SSP (intrinsic viscosity post-polycondensation), IV-COMP (intrinsic viscosity pre-polycondensation and calculated value of dIV/dt.

### Example 4

In this example, various organic phosphite antioxidants were analyzed to determine the effect on a polycondensed polyester composition. The organic phosphite antioxidants are as follows:
Additive 1—bis(2,4,di-t-butylphenyl)pentaerythritol diphosphite
Additive 2—phosphorous acid, mixed 2,4-bis(1,1-dimethylpropyl)phenyl and 4-(1,1-dimethylpropyl)phenyl triesters with TIPA
Additive 3—tris(2,4-di-t-butylphenyl)phosphite
Additive 4—distearylpentaerythritol diphosphite (w/<1 wt. % triisopropanolamine)
Additive 5—triphenyl phosphite.

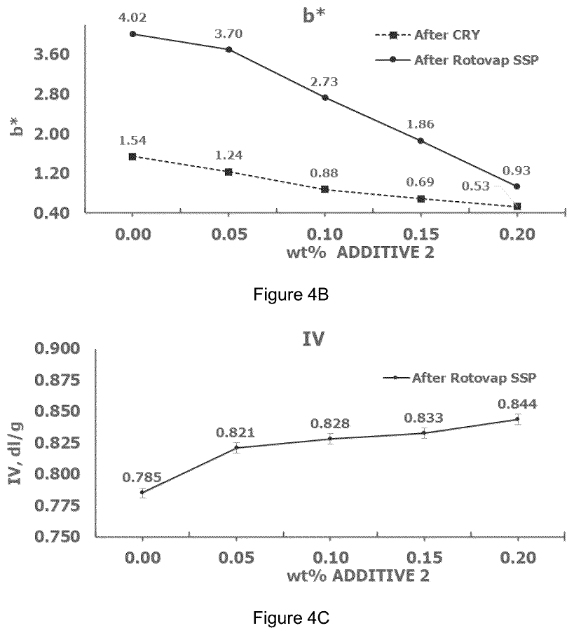

The color profile and the intrinsic viscosity of each composition was determined. As illustrated in FIG. 3, the benefit of deploying phosphites is highlighted in both maintaining or increasing the rate of change of IV (dIV/dt) after a 2 hour TGA-SSP but also the apparent impact/benefit on the yellowness (b*) of compounded recycled polyethylene terephthalate (rPET) flake after it is subjected to compounding and TGA-SSP. These rPET pellets show improvements at levels that are significantly improved over untreated control rPET compounds (encircled data point) that went through the same exact processing steps as the samples with the additives.

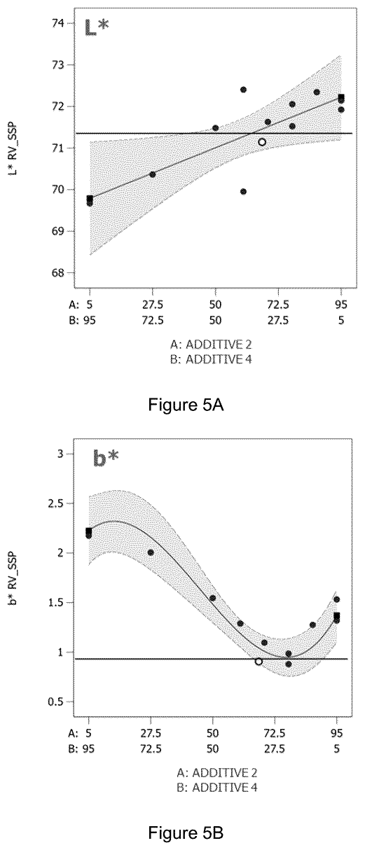

In addition, the dose response of a single additive (Additive 2) across a lower range of dosages (0.05 wt. % to 0.20 wt. %) was analyzed. As shown in FIG. 4A, the final color benefits reveal that the L* value is increased above the control at 0.05 wt. % of Additive 2. Upon increasing the treat rate of this phosphite, the L* is slightly lowered to a level than is in the same range as the unaddivated compound.

Upon evaluating the b* data in FIG. 4B, the trend indicates a steady decline in b*, or, also defined as a perceived reduction in yellowness, across the entire treatment range with Additive 2 after compounding, crystallization, and 6 hour rotovap-SSP. Also, apparent in the performance data of FIG. 4C is a trend in the measured final solution IV of the pelletized rPET compounds again after compounding, crystallization, and 6 hour rotovap SSP. The trend in solution IV (SIV) reveals that higher molecular weights are obtained across the entire treatment range with Additive 2. It is important to note that these same trends were observed for rPET compounds with Additive 2 when using TGA-SSP processing but at treat rates that spanned 0.10-0.40 wt. %. Even within the lower treatment ranges of 0.05-0.20%, the same benefit in increasing the IV relative to a control sample toward higher values is observed again.

### Example 5

In this example, a blend of two organic phosphite antioxidants to determine its effect on a polycondensed polyester composition after rotovap-SSP. The organic phosphite antioxidants are as follows:
Additive 2—phosphorous acid, mixed 2,4-bis(1,1-dimethylpropyl)phenyl and 4-(1,1-dimethylpropyl)phenyl triesters with TIPA
Additive 4—distearylpentaerythritol diphosphite (w/<1 wt. % triisopropanolamine).

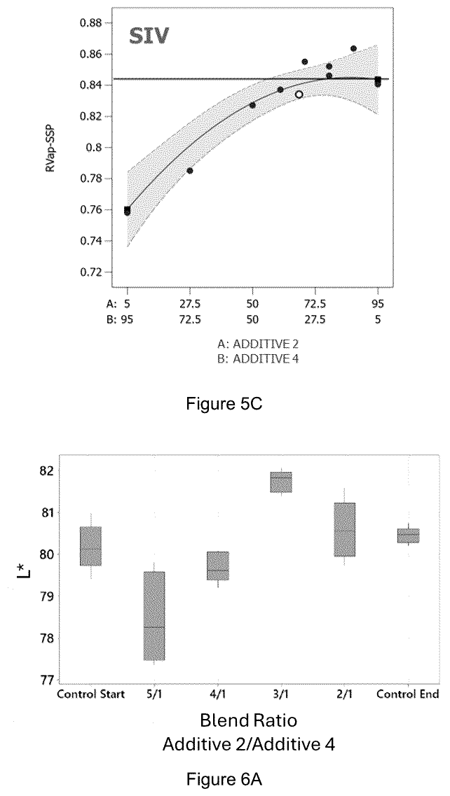

The color properties of the processed pellets reveal that as levels of Additive 4 are increased in the compounded blend that the L* value decreases (darkens) (FIG. 5A). Conversely, the trend in the data could be interpreted in such a way to indicate that as the amount of Additive 2 is increased in the blend that the L* also increases. By drawing an additional comparison to the 100% compound of Additive 2 (black trend line in chart), an additional benefit in L* becomes apparent at higher ratios of Additive 2 to Additive 4 relative to the single component Additive 2 compound. The brightness of processed pellets trend to higher responses when compared to the reference compound of 100% Additive 2. For reference, 100% Additive 2 at 0.20 wt. % in the same rPET flake had measured final L*, b*, and SIV values of 71.35, 0.93, and 0.844, respectively.

On the other hand, the b* color responses (FIG. 5B) do not follow a linear trend but possess significant curvature indicating possible synergy for influencing the b* value. Taking into consideration the b* reference line of 100% Additive 2 and the 95% confidence intervals of the b* response in the plot, the optimum b* (lowest point in modeled data) appears in ranges higher than approximately 60% of Additive 2 in the 2-way blend with Additive 4.

Considering together both the L* and b* responses, it would also suggest that above the blend ratio of 60% Additive 2, a benefit may be provided to simultaneously control the relative brightness and yellowness of rPET pellets without the need to add blue toners. Because b* values are maintained low as a part of a stabilization benefit, that is in a direct response for these phosphites in preventing degradation that leads to the darkening and yellowing of rPET.

The response in SIV (FIG. 5C) for these phosphite blends in rPET compounds also revealed a subtle curvature in its response with higher final values above the blend ratio of 60% Additive 2 relative to the horizontal trend line for 100% Additive 2.

### Example 6

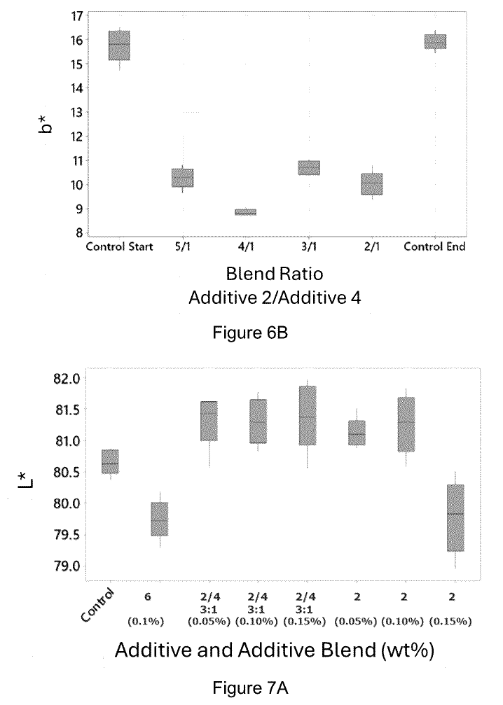

Similar to Example 5, blends of Additive 2 and Additive 4 were utilized in determining the effect on a polycondensed polyester composition. In particular, blends of Additive 2 and Additive 4 were provided in an amount of 0.20 wt. % in 5 lb batches of rPET flake to produce suitable pellets for injection molding into 3.0 mm thick plaques. The results of the color measurements are illustrated in FIGS. 6A and 6B.

In FIG. 6A, the L* value reaches an apparent maximum at or around the blend ratio of 3/1 of Additive 2 to Additive 4—with a value higher (brighter) than the control without any phosphite in the plaque. For b* (FIG. 6B), the values remain quite low with similar values that are approximately 6 units lower in b* yellowness relative to the control plaques without any phosphite.

The response in SIV for these larger scale batches of rPET compounds also revealed increases in final IV relative to the control compound as shown in the table below.

| rPET Compound | Post SSP SIV | SSP Rate |
|---|---|---|
| (Additive 2/Additive 4) | (dL/g) | (dIV/dt) |
| Control (no phosphite) | 0.756 | 0.010 |
| 2/1 Blend | 0.799 | 0.014 |
| 3/1 Blend | 0.814 | 0.018 |
| 4/1 Blend | 0.852 | 0.022 |
| 5/1 Blend | 0.815 | 0.016 |

During SSP processing, each batch was sampled periodically to evaluate the rate of change in IV over the duration of the 6 hour SSP process. Relative to the blank, the addivated compounds obtained higher final SIV which would indicate that these phosphites actively participate in the underlying dynamic system chemistry of the rPET polyester and transesterification processes that occur, offering a slight acceleration in IV growth over the 6 hour period. Each compound also had slightly higher rates of change of IV (dIV/dt) with the peak change occurring for the 4/1 blend of Additive 2/Additive 4.

### Example 7

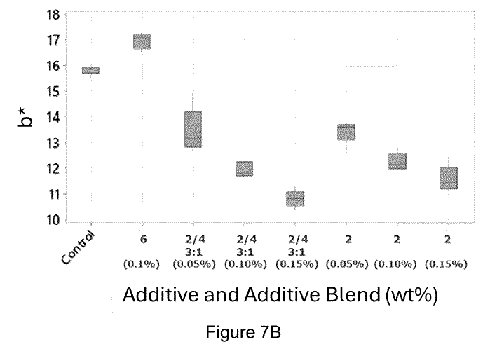

With the observed peak in performance for the blend of Example 6 to exist around the 3:1 blend ratio of Additive 2 and 4, respectively, a series of dose response experiments were carried out across levels of total phosphite of 0.05-0.15 wt. % for the 3:1 blend. All of the compounds for this study were again processed under approved APR processing conditions on 5 lb-batches of rPET flake to produce suitable pellets for injection molding 3.0 mm thick plaques. The results from these plaque color measurements are shown in FIGS. 7A and 7B.

The blends in this study were also compared to a commercial benchmark (Additive 6 at 0.10 wt. %) and Additive 2 across a range of levels that also span 0.05-0.15 wt. %. The L* color data (FIG. 7A) indicates that the 3:1 blend outperforms the control (no phosphite), benchmark Additive 6 (0.10 wt. %) and Additive 2 at 0.15 wt. %. The drop in L* performance for Additive 2 is in line with previous data, but at a level of 0.10 wt. %, Additive 2 outperforms benchmark Additive 6. The compounded blends of 3:1 Additive 2/4 and the Additive 2 significantly outperform both the unaddivated control compound and the compound prepared with Additive 6 at 0.10 wt. %. The previous trend in further improvement is also evident (reduction of yellowness) for b* (FIG. 7B) as the treat rate is increased for compounded blends of 3:1 Additive 2/4 and the Additive 2, the b* value is greatly reduced relative to the control and benchmark Additive 6.

At certain treat rates with the 3:1 blend of Additive 2/4 and the single component Additive 2, the rate of viscosity build (table below) during SSP can be managed such that the final IV is not impacted relative to an unaddivated rPET sample. It is important to note that the functional alternative commercial sample (Additive 6) is described to reduce color without influencing the IV. It can be seen from this data in FIGS. 7A and 7B and the table below that Additive 6 detrimentally darkens (L* decreases) and yellows (b* increases) and greatly reduces the IV relative to the controls and the other embodiments.

| | | |
|---|---|---|
| rPET Compound | Post SSP SIV | SSP Rate |
| (Additive or Additive Blend) | (dL/g) | (dIV/dt) |

| | | | |
|---|---|---|---|
| Control | (no phosphite) | 0.851 | 0.019 |
| 6 | (0.10 wt. %) | 0.808 | 0.013 |
| 2/4 | (3:1; 0.05 wt. %) | 0.824 | 0.015 |
| 2/4 | (3:1; 0.10 wt. %) | 0.846 | 0.016 |
| 2/4 | (3:1; 0.15 wt. %) | 0.854 | 0.017 |
| 2 | (0.05 wt. %) | 0.827 | 0.017 |
| 2 | (0.10 wt. %) | 0.855 | 0.018 |
| 2 | (0.15 wt. %) | 0.859 | 0.019 |

Blends of Additive 2/4 highlight the unanticipated benefit of controlling IV, L*, and b* in such a way as to improve the quality of the rPET pellet. Contrary to what is known in the art, that the use of alkylphosphites should be avoided, as these phosphites are described to promote degradation of the PET polymer, more commonly alluding to the observed reduction in the melt viscosity in extrusion or mixing bowl experiments at high loadings approaching 2 wt. %—but in melt processes and not SSP processes. This perceived degradation is related to the system-chemistry-equilibrium of polyester that exists between the carboxylic acid and glycol chain ends for any given rPET source (ratios will change), and it is how these functional groups and the PET-ester backbone respond to thermal processes and the reactions that accelerate hydrolysis or transesterification leading to IV losses and gains, respectively-along with unwanted changes in color.

Further, balancing/managing IV build and color quality for PCR-PET carried through a recycling process with phosphite blends (alkyl and aryl-phosphites) instead of a single phosphite solution can be possible. In particular, the phosphite blends can be tailored to actively participate in the complex chemistry to create a subclass of modified chain ends that carry a distribution of aryl-esters and alky-esters formed as co-products appended to glycol chains-ends of the polyester. Depending on the electronic influence and steric hindrance of substituents on alkyl and aryl components of the phosphites, the relative rates of reactivity can be further balanced to control the extent of transesterification and reactions that impact IV.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

1. A method of preparing a polyester, the method comprising:
adding a recycled polyester material and one or more organic phosphite antioxidants into a melt blending apparatus;
melt blending the recycled polyester material and the one or more organic phosphite antioxidants to form a melt-blended polyester composition; and
polycondensing the melt-blended polyester composition via solid-state polymerization or liquid-state polymerization to form a polycondensed polyester composition comprising a polycondensed polyester and the one or more organic phosphite antioxidants;
wherein the polycondensed polyester composition exhibits an L* value of 60 or more and a b* value of 20 or less as determined in accordance with PET-S-09 (revision date Sep. 3, 2024).

2. The method of claim 1, wherein the polycondensed polyester composition exhibits a yellowness index of 4 or less as determined in accordance with ASTM E313-20.

3. The method of claim 1, wherein the polycondensed polyester composition exhibits an L* value of 67 or more and a b* value of 15 or less.

4. The method of claim 1, wherein the recycled polyester material comprises a recycled polyethylene terephthalate.

5. The method of claim 1, wherein the one or more organic phosphite antioxidants comprise a phosphite ester.

6. The method of claim 5, wherein the phosphite ester comprises an alkylphosphite ester, an arylphosphite ester, an alkylarylphosphite ester, or a mixture thereof.

7. The method of claim 1, wherein the one or more organic phosphite antioxidants comprise a pentaerythritol diphosphite.

8. The method of claim 1, wherein the one or more organic phosphite antioxidants comprise a blend of an arylphosphite ester and a pentaerythritol diphosphite.

9. The method of claim 1, wherein the one or more organic phosphite antioxidants comprise bis(2,4,di-t-butylphenyl)pentaerythritol diphosphite (CAS 26741-53-7); 2,4,6-tri-tert-butylphenyl-2-butyl-2-ethyl-1,3-propanediol phosphite (CAS 161717-32-4); tris(2,4-di-t-butylphenyl)phosphite (CAS 31570-04-4); tetrakis(2,4-di-t-butylphenyl)4,4′-biphenylene diphosphonite (CAS 38613-77-3); tris(4-n-nonylphenyl)phosphite (CAS 26523-78-4); distearylpentaerythritol diphosphite (CAS 3806-34-6); triphenyl phosphite (CAS 101-02-0); bis(2,4-dicumylphenyl)pentaerythritol diphosphite (CAS 154862-43-8); phosphorous acid, mixed 2,4-bis(1,1-dimethylpropyl)phenyl and 4-(1,1-dimethylpropyl)phenyl triesters (CAS 939402-02-5); tris(dipropyleneglycol)phosphite, C18H3909P (CAS 36788-39-3); poly(dipropylene glycol)phenyl phosphite (CAS 80584-86-7); diphenyl isodecyl phosphite, C22H31O3P (CAS 26544-23-0); phenyl diisodecyl phosphite (CAS 25550-98-5); heptakis (dipropyleneglycol)triphosphite (CAS 13474-96-9); bis(2,6-di-tert-butyl-4-methylphenyl)pentaerythritol diphosphite (CAS 80693-00-1); tris(2-t-butylphenyl)phosphite (CAS 31502-36-0); trisphenyl phosphite; or a mixture thereof.

10. The method of claim 9, wherein the one or more organic phosphite antioxidants comprise a blend of at least any two of bis(2,4,di-t-butylphenyl)pentaerythritol diphosphite (CAS 26741-53-7); tris(2,4-di-t-butylphenyl)phosphite (CAS 31570-04-4); distearylpentaerythritol diphosphite (CAS 3806-34-6); phosphorous acid, mixed 2,4-bis(1,1-dimethylpropyl)phenyl and 4-(1,1-dimethylpropyl)phenyl triesters (CAS 939402-02-5); and trisphenyl phosphite.

11. The method of claim 1, wherein the one or more organic phosphite antioxidants comprise a blend of at least two organic phosphite antioxidants, the blend including a primary antioxidant in an amount of 60 wt. % or more the weight of the one or more organic phosphite antioxidants.

12. The method of claim 1, wherein the one or more organic phosphite antioxidants is a liquid at ambient conditions.

13. The method of claim 1, wherein the one or more organic phosphite antioxidants has a melting point of 100° C. or less.

14. The method of claim 1, wherein the one or more organic phosphite antioxidants is present in the polycondensed polyester composition in an amount of 0.01 wt. % or more to 2 wt. % or less based on the weight of the polycondensed polyester composition.

15. The method of claim 1, wherein the polycondensed polyester composition further comprises a phenolic antioxidant, a metal chelator, an acid scavenger, or a mixture thereof.

16. The method of claim 1, wherein the polycondensed polyester composition further comprises a hydrolyzed derivative of at least one of the one or more organic phosphite antioxidants.

17. The method of claim 1, wherein the polycondensed polyester composition exhibits an intrinsic viscosity of 0.5 dl/g or more as determined in accordance with ASTM D4603-18.

18. A method of preparing a polyester, the method comprising:
adding a recycled polyester material and one or more organic phosphite antioxidants into a melt blending apparatus;
melt blending the recycled polyester material and the one or more organic phosphite antioxidants to form a melt-blended polyester composition having a first intrinsic viscosity; and
polycondensing the melt-blended polyester composition via solid-state polymerization or liquid-state polymerization to form a polycondensed polyester composition comprising a polycondensed polyester and the one or more organic phosphite antioxidants;
wherein the polycondensed polyester composition has a second intrinsic viscosity greater than the first intrinsic viscosity and wherein the polycondensed polyester composition exhibits an intrinsic viscosity of 0.5 dl/g or more as determined in accordance with ASTM D4603-18.

19. The method of claim 18, wherein the polycondensed polyester composition exhibits an L* value of 67 or more and a b* value of 20 or less as determined in accordance with PET-S-09 (revision date Sep. 3, 2024).

20. A polycondensed polyester composition comprising:
a polycondensed polyester formed from a recycled polyester material; and
one or more organic phosphite antioxidants;
wherein the polycondensed polyester composition exhibits an L* value of 60 or more and a b* value of 20 or less as determined in accordance with PET-S-09 (revision date Sep. 3, 2024) and an intrinsic viscosity of 0.5 dl/g or more as determined in accordance with ASTM D4603-18.

21. A method of preparing a polyester, the method comprising:
adding a recycled polyester material and one or more organic phosphite antioxidants into a melt blending apparatus, wherein the recycled polyester material has an L* value and a b* value as determined in accordance with PET-S-09 (revision date Sep. 3, 2024);
melt blending the recycled polyester material and the one or more organic phosphite antioxidants to form a melt-blended polyester composition; and
polycondensing the melt-blended polyester composition via solid-state polymerization or liquid-state polymerization to form a polycondensed polyester composition comprising a polycondensed polyester and the one or more organic phosphite antioxidants;
wherein the polycondensed polyester composition exhibits an L* value and a b* value as determined in accordance with PET-S-09 (revision date Sep. 3, 2024), wherein the L* value of the polycondensed polyester composition is greater than or equal to about the L* value of the recycled polyester material minus 3 and the b* value of the polycondensed polyester composition is less than or equal to about the b* value of the recycled polyester material plus 2.
